(19) United States
(12) Patent Application Publication
(10) Pub. No.: US 2014/0113485 A1
(43) Pub. Date: Apr. 24, 2014

(54) HDMI, VGA, Component, & Coax recessed receptacles

(71) Applicant: Manuel Jose Garcia, Las Vegas, NV (US)

(72) Inventor: Manuel Jose Garcia, Las Vegas, NV (US)

(73) Assignee: Manuel Jose Garcia, Las Vegas, NV (US)

(21) Appl. No.: 13/423,267

(22) Filed: Oct. 23, 2012

(51) Int. Cl. H01R 13/74

(52) U.S. Cl. CPC H01R 13/748
USPC 439/540.1

(57) ABSTRACT

Low voltage TV input receptacles, that can be single or ganged together in numerous configuration, with a recessed device. It eliminates the need to locate a specific electrical box or plaster ring, because each piece is cut into, and clips onto the wallboard. The clips can be removed, for new construction, and the devices can be used with a electrical box or plaster ring. It easily accommodates future expansion. In addition, it allows flush mounting of television, and flush placement of furniture.

### CROSS-REFERENCE TO RELATED APPLICATIONS

This application claims the benefit of provisional patent application Ser. No. 61/369,859, filed Aug. 2, 2010 by the present inventor.

### FEDERALLY SPONSORED RESEARCH

Not Applicable

### SEQUENCE LISTING OR PROGRAM

Not Applicable

### BACKGROUND OF INVENTION

1. Field of Invention

This invention relates to low voltage wall receptacles, specifically to such receptacles which are used to provide signal to Televisions.

2. Prior Art

With the change to high definition televisions, a television is now commonly wall mounted as a picture frame, and the wiring is ran through the wall.

Old picture tube televisions were mounted in or on furniture, and that configuration allowed for the concealment of the wiring.

Yesterday's low voltage receptacles do not allow for a television to be mounted flush to a wall, nor do they allow for a piece of furniture under the television to be placed flush to the wall.

Modern television inputs are too varying and numerous to be adequately matched by existing receptacle configurations. Receptacle's are limited by the size of available boxes or plaster rings.

### OBJECTS AND ADVANTAGES

Accordingly, several objects and advantages of my invention are:

(a) It is a single and gangable system for in the wall TV inputs.

(b) The receptacles are configured as individual, left, right, and center modules.

(c) The receptacles can be joined together in numerous configurations, to conform to the individual user's needs.

(d) Each receptacle has a wall clip, eliminating the need for an electrical box, or plaster ring, and is, therefore, a complete installation unit.

(e) The wall clip may be removed for mounting into existing electrical boxes, or plaster rings.

(f) It allows TV input wiring to be placed in the wall, and out of sight. The receptacles are recessed to allow flush mounting of TV and furniture, for better aesthetics.

(g) The product is to be manufactured of molded plastic and is one piece. The wall clip rotates and tightens on it's screw as it hits it's stopper.

Further objects and advantages are that the receptacles are adaptable to new construction and remodeling, in any configuration imaginable.

### SUMMARY

The uniqueness of this invention is that low voltage TV inputs can now be ganged together in numerous configuration, with a recessed device. It eliminates the need to locate a specific electrical box or plaster ring, because each piece is cut into, and clips onto the wallboard. This makes the system adaptable to future remodel expansion, as new sections can be added without having to change internal supports. The clips can be removed, for new construction, and the devices can be used with a electrical box or plaster ring.

### DRAWINGS

Figures

### HDMI & Coax Recessed Receptacle

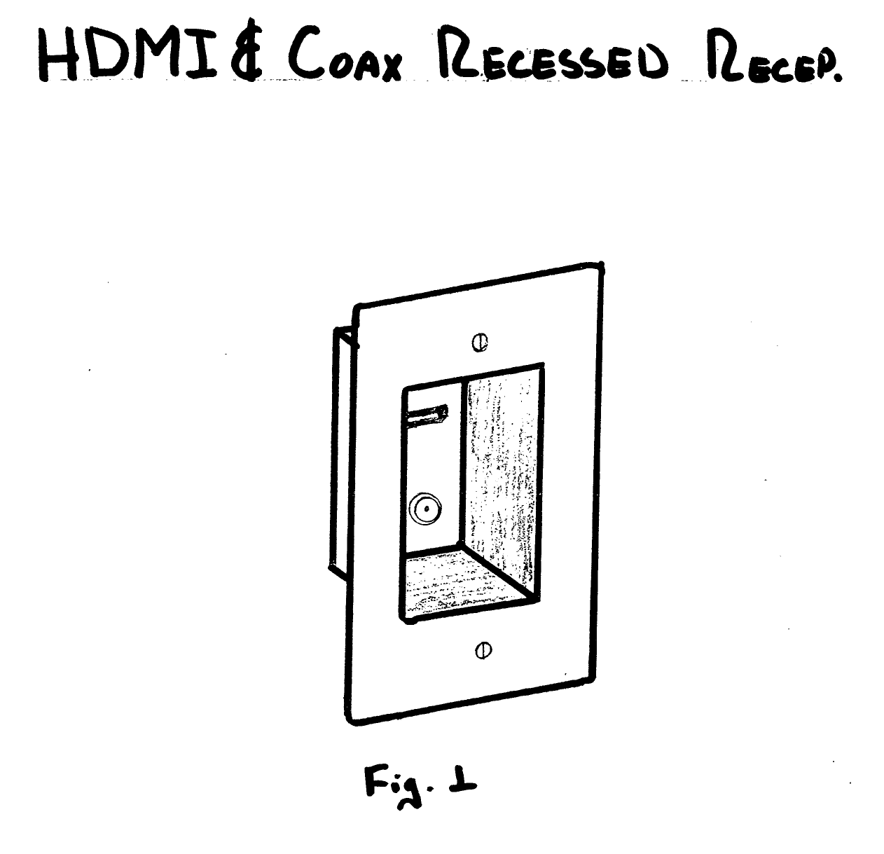

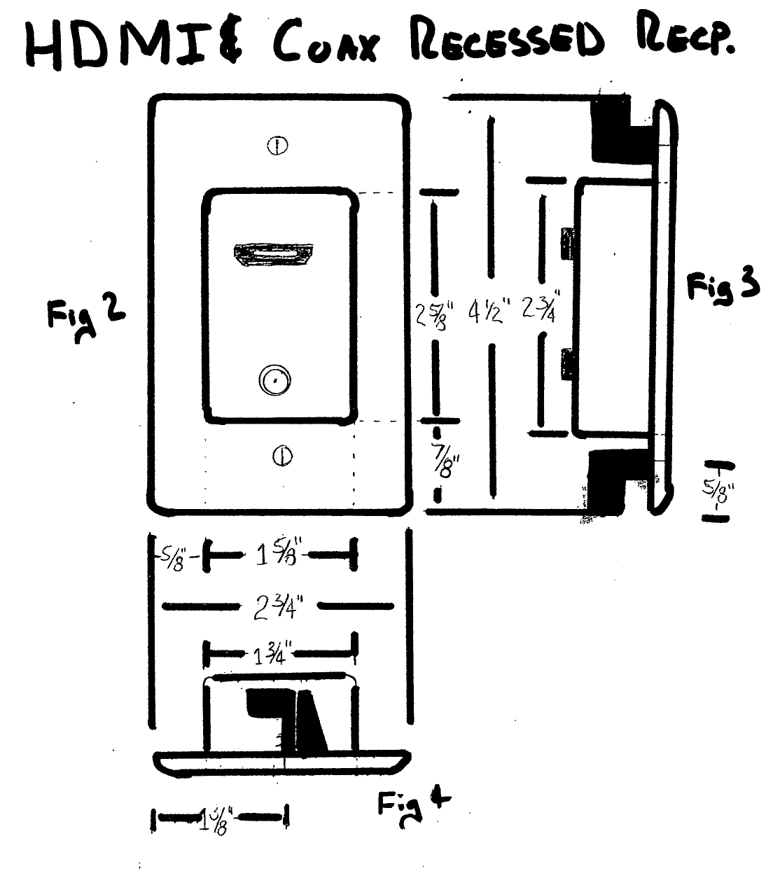

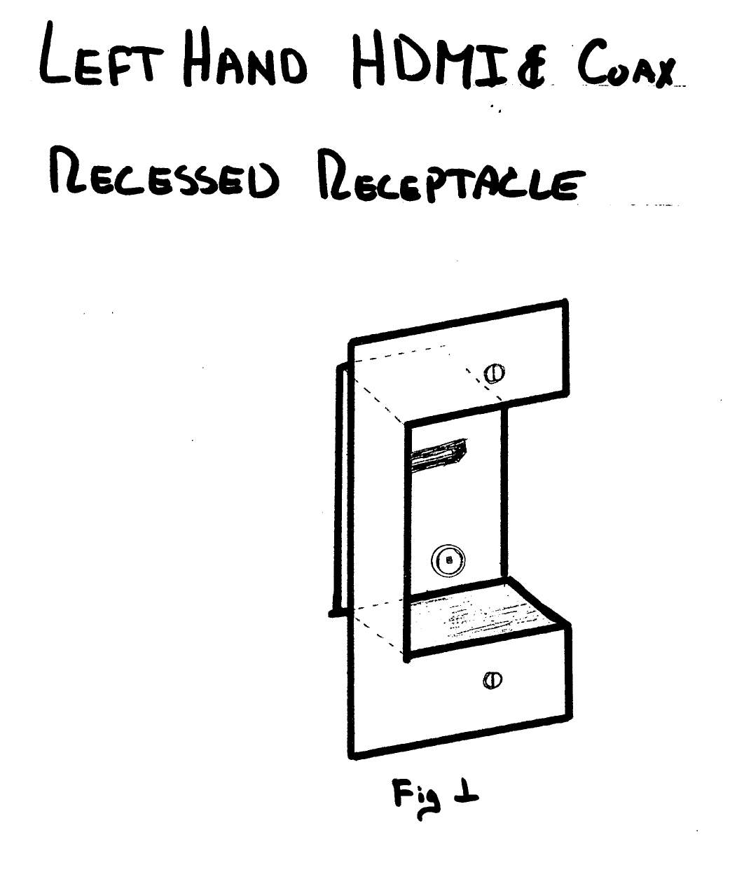

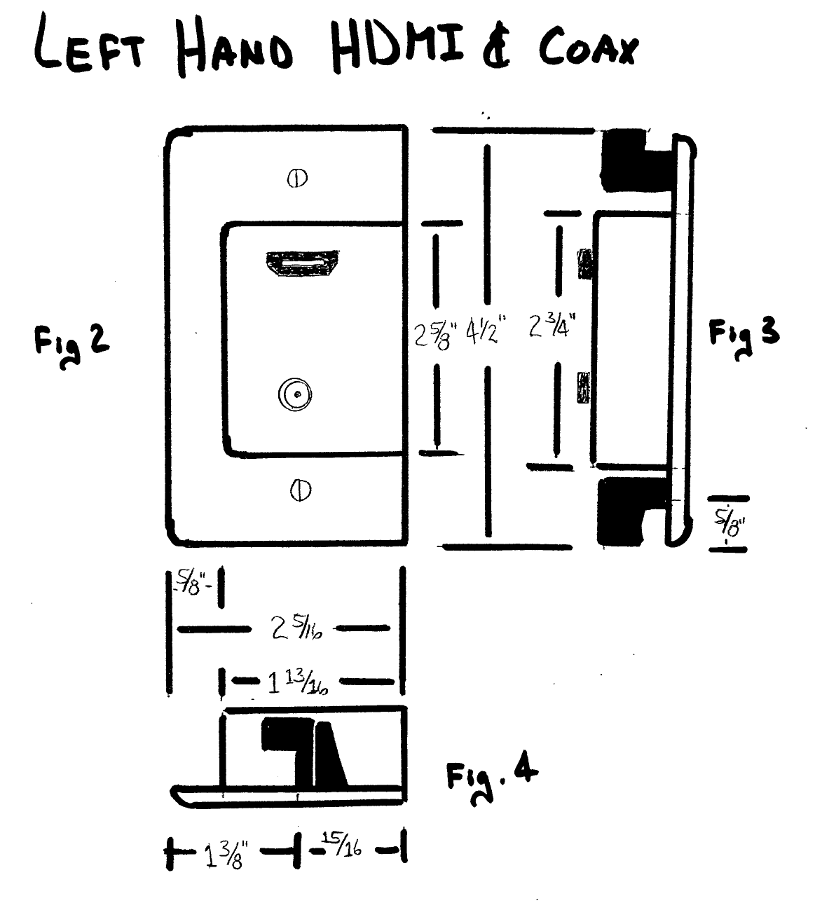

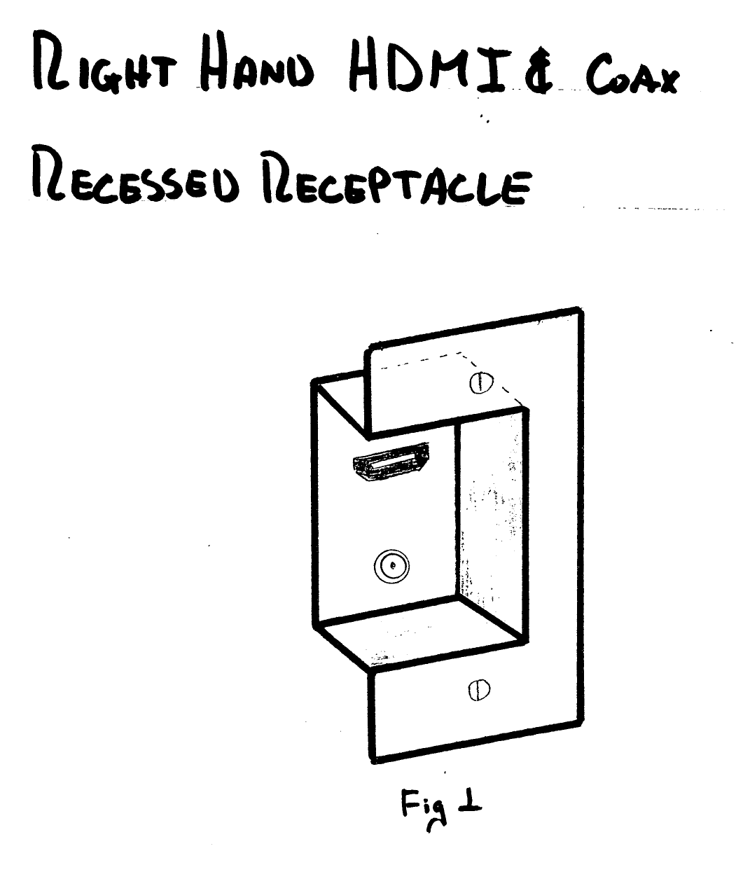

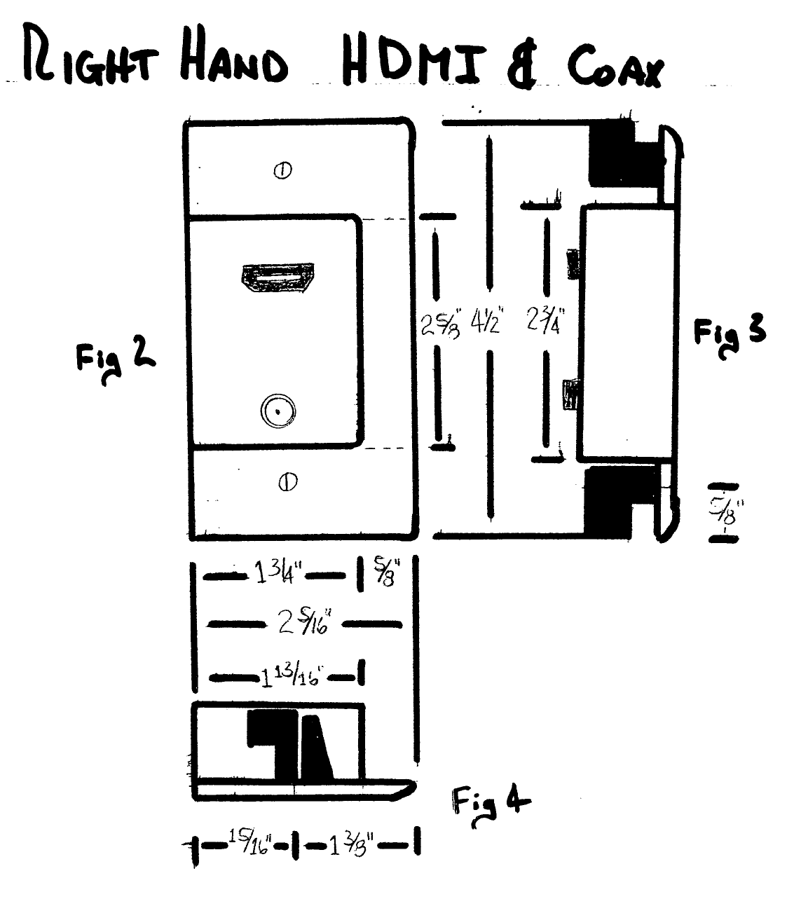

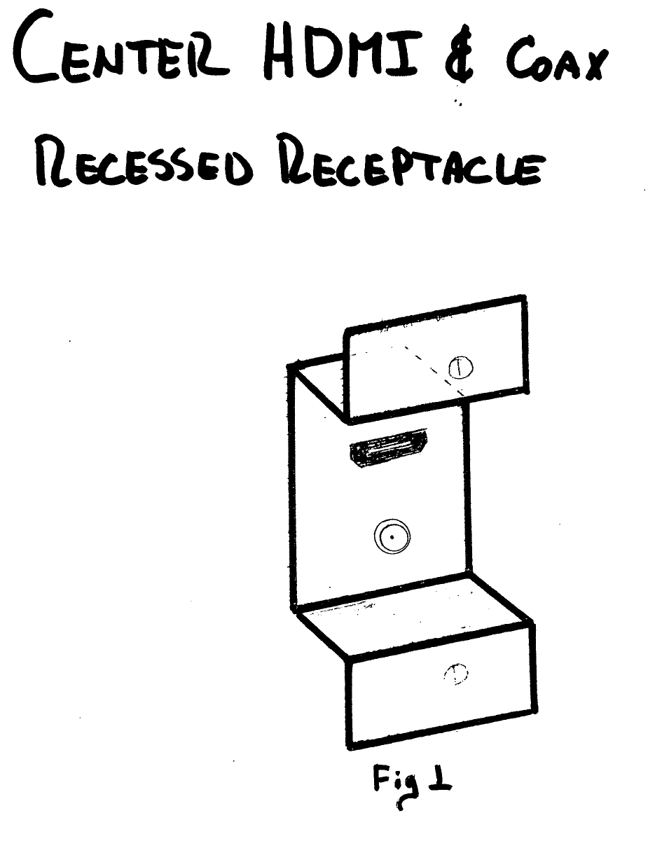

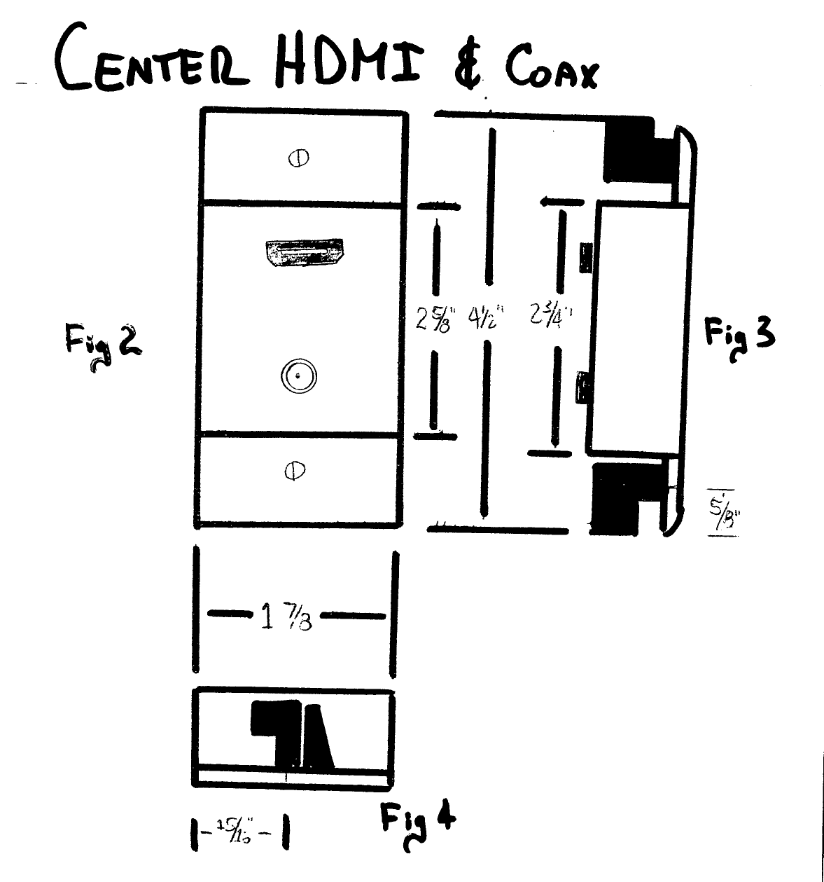

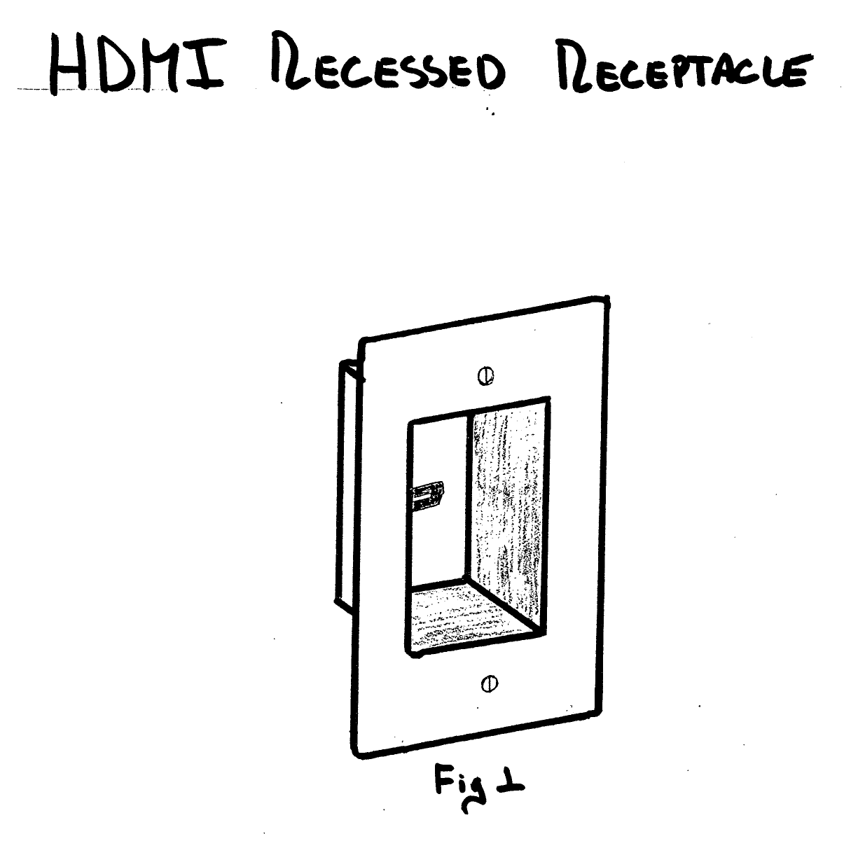

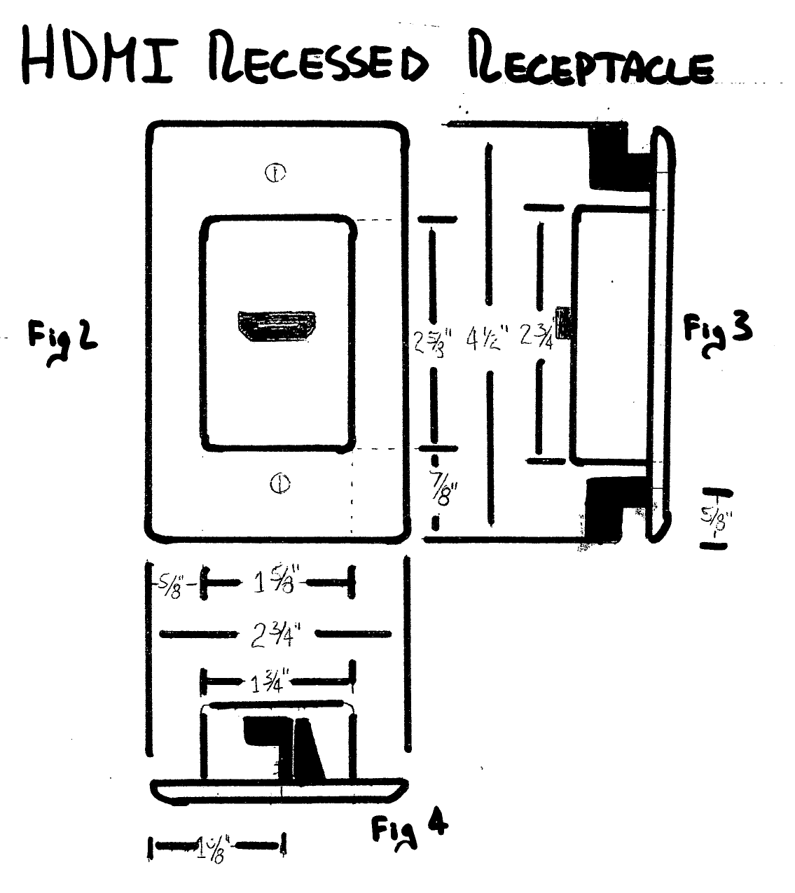

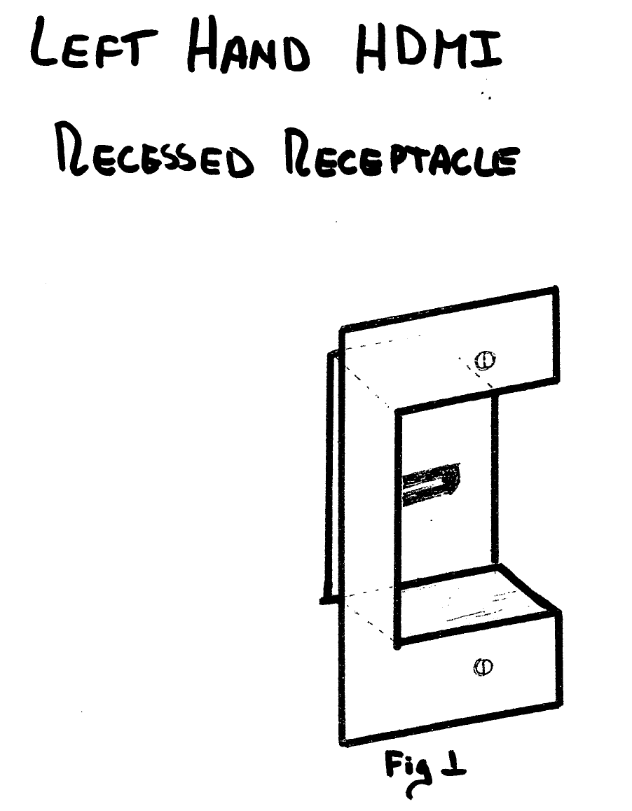

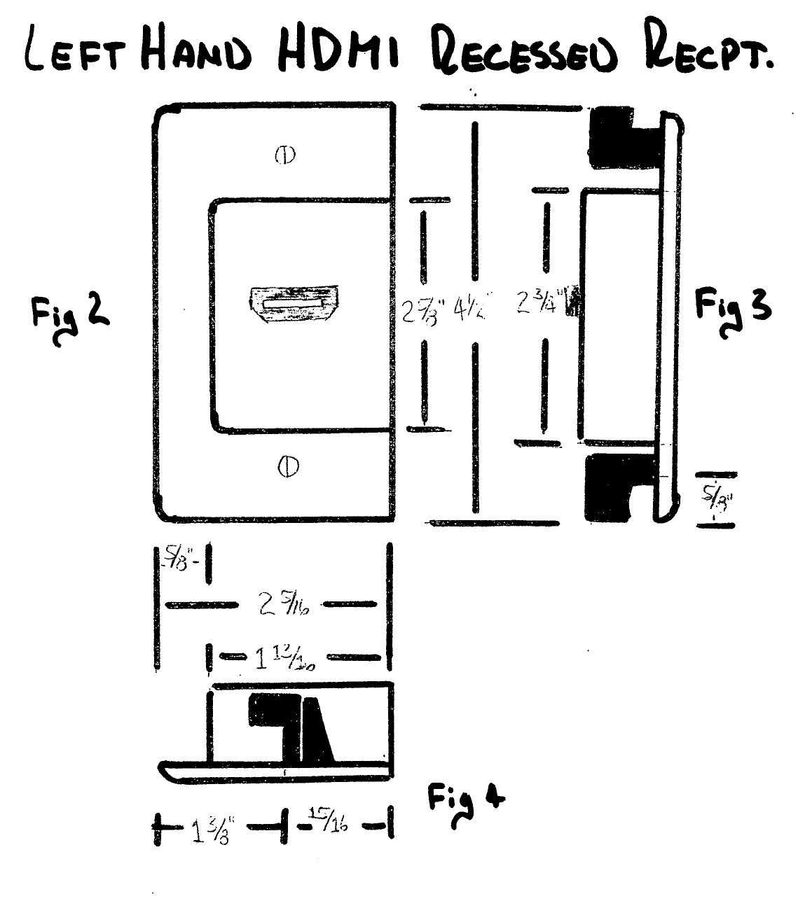

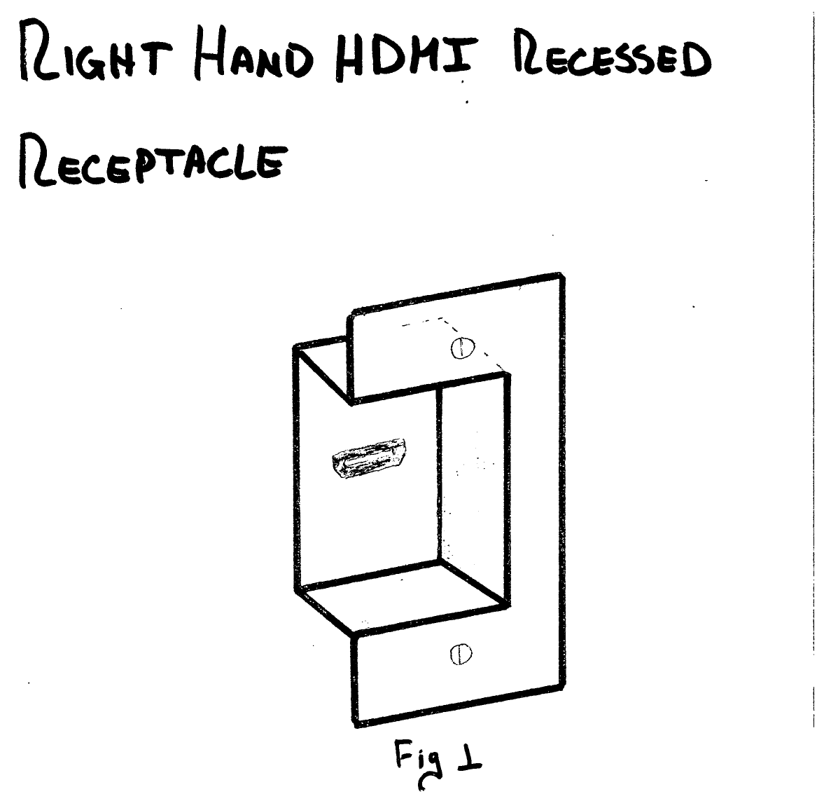

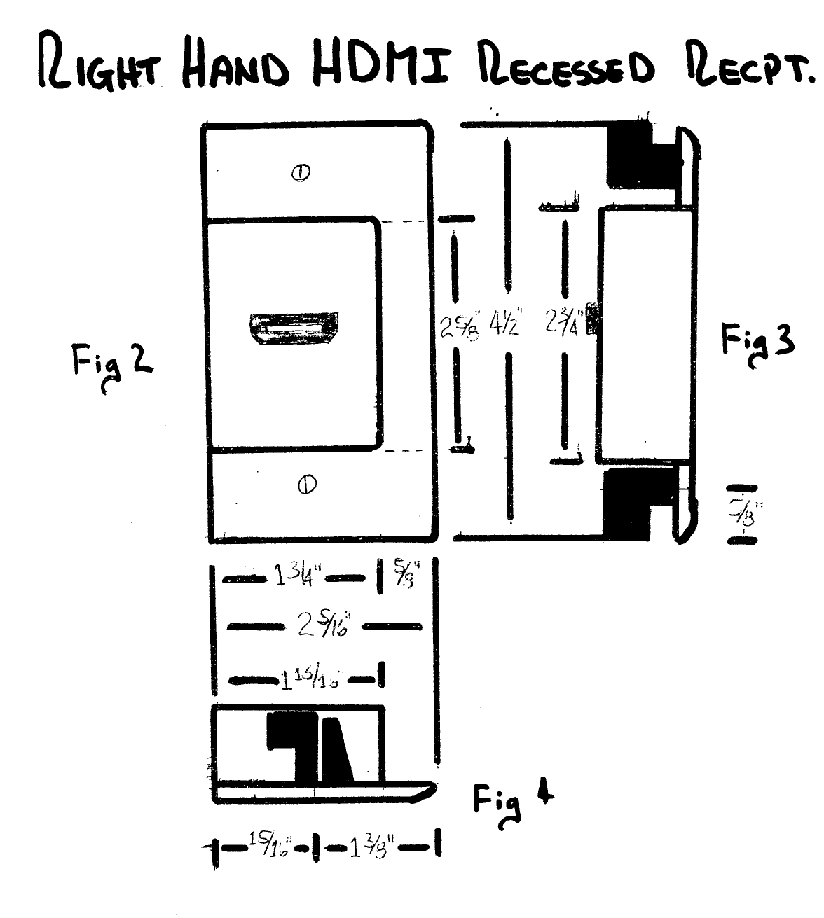

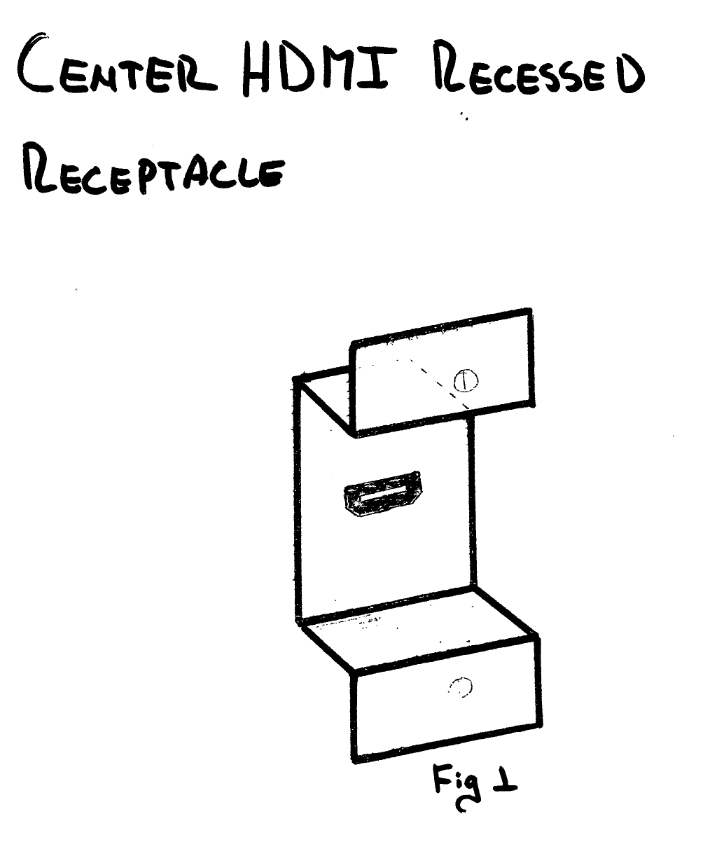

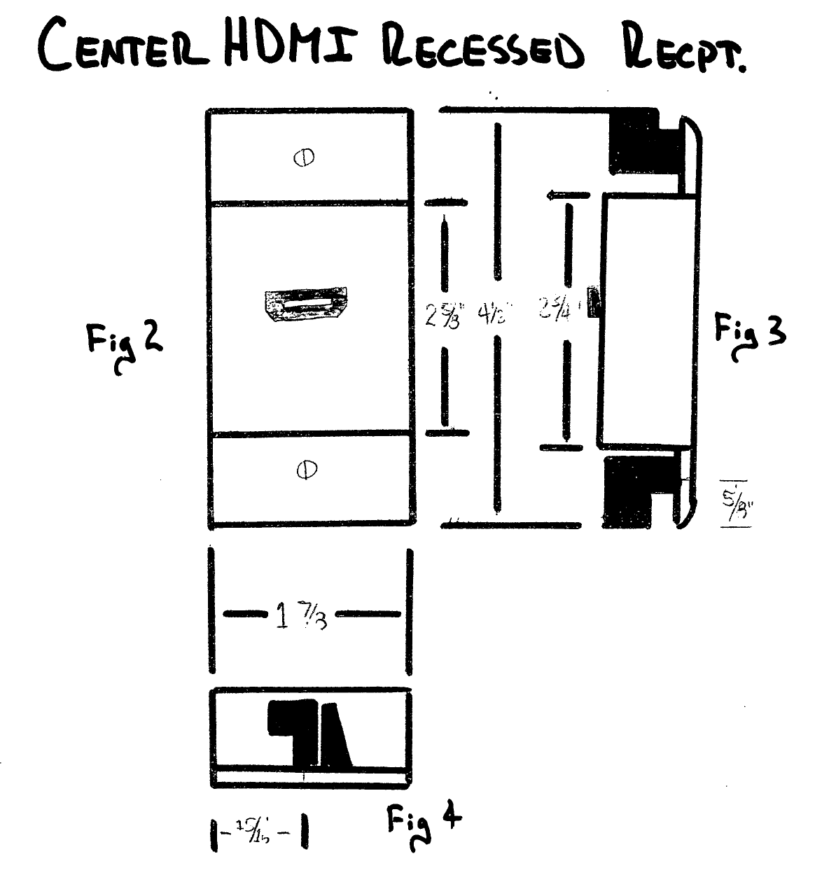

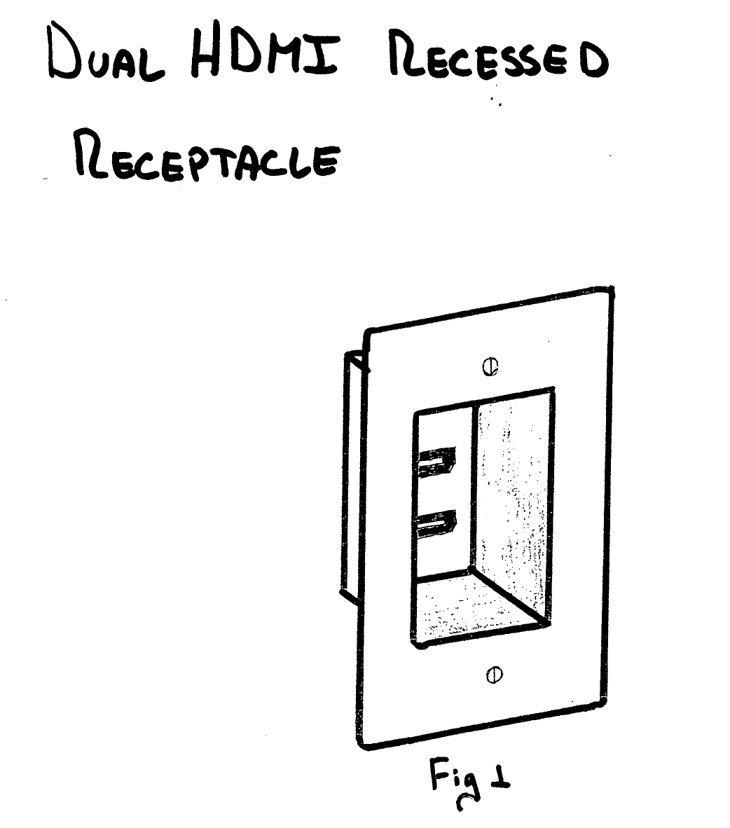

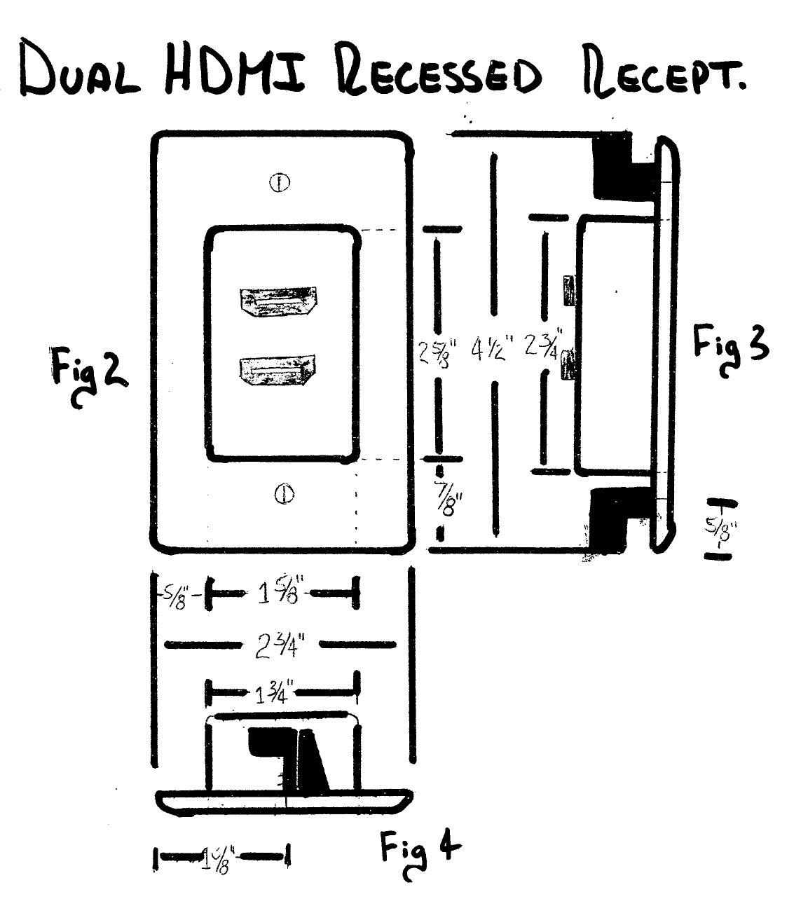

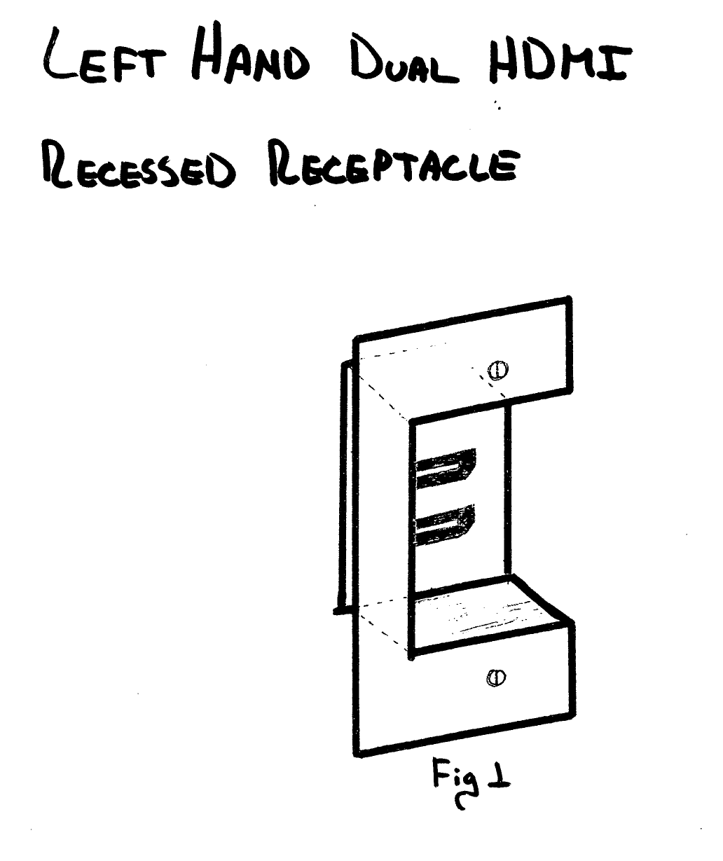

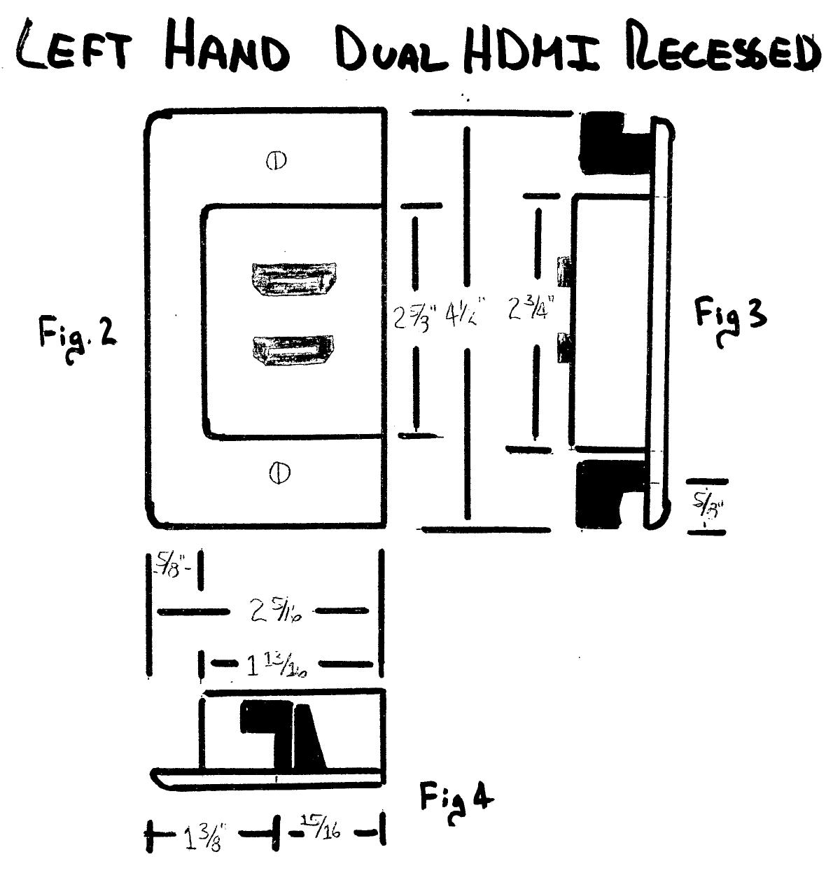

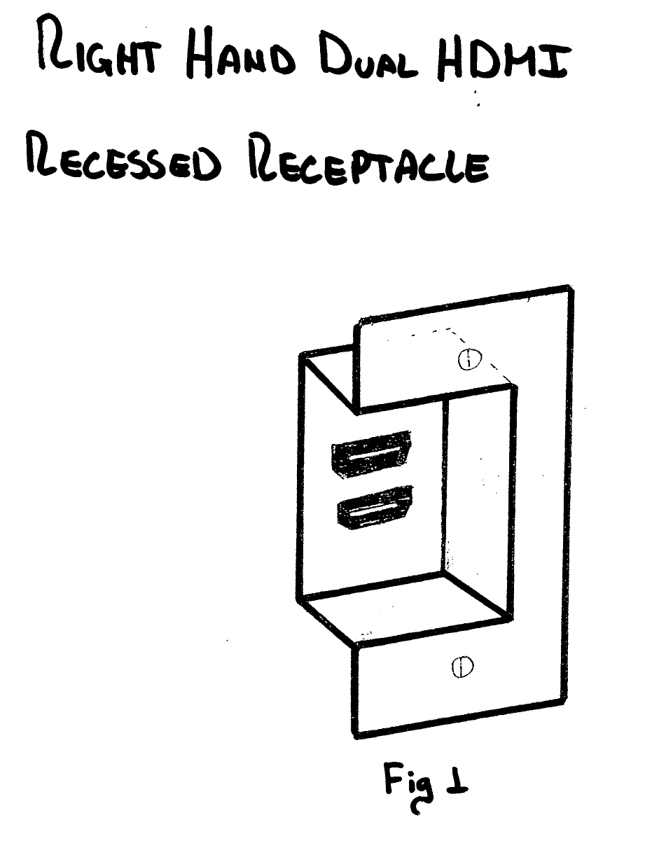

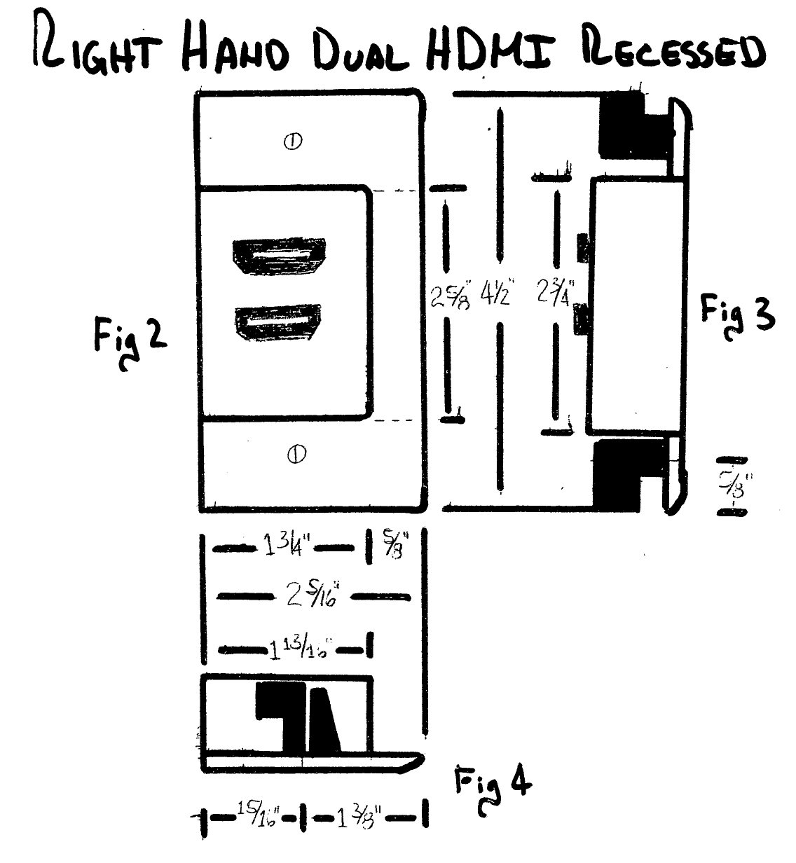

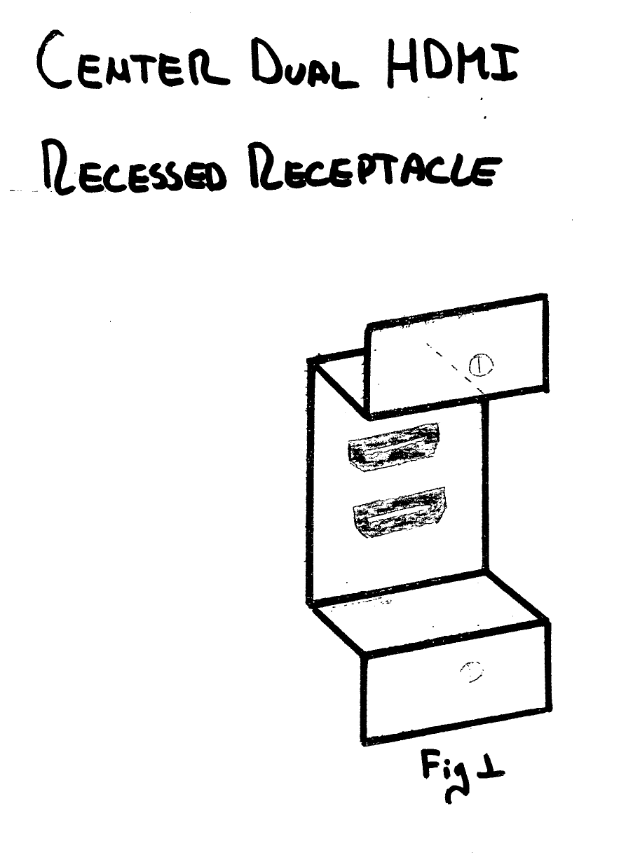

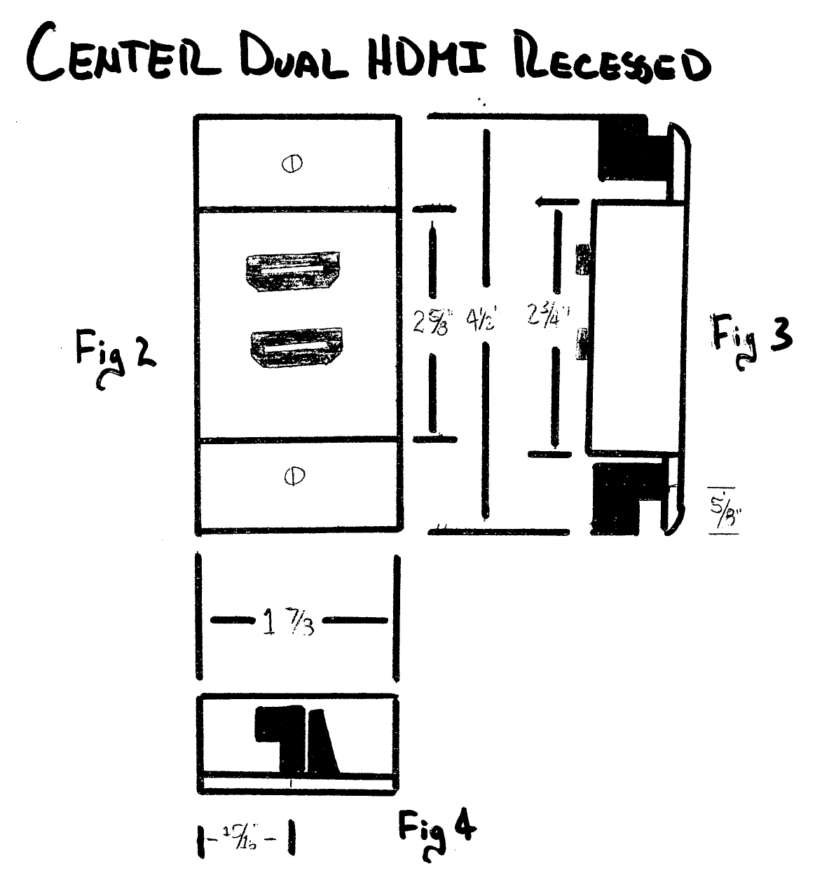

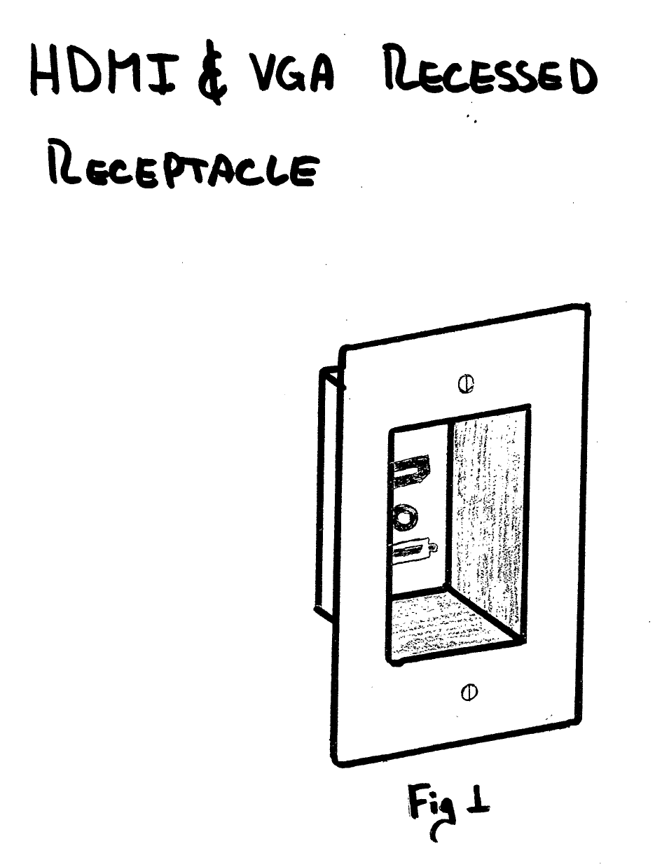

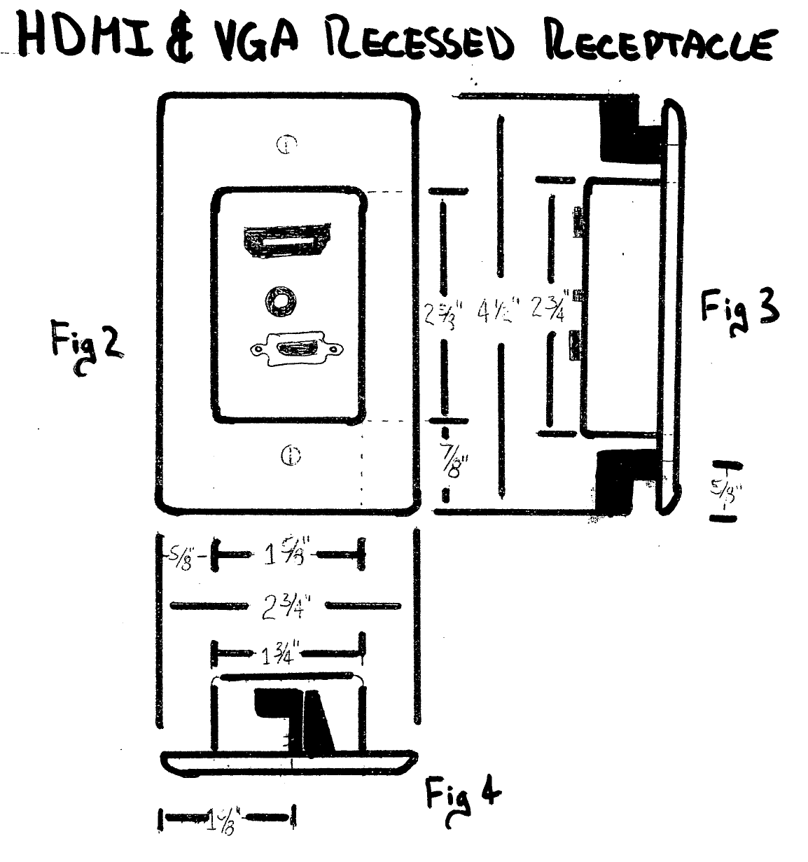

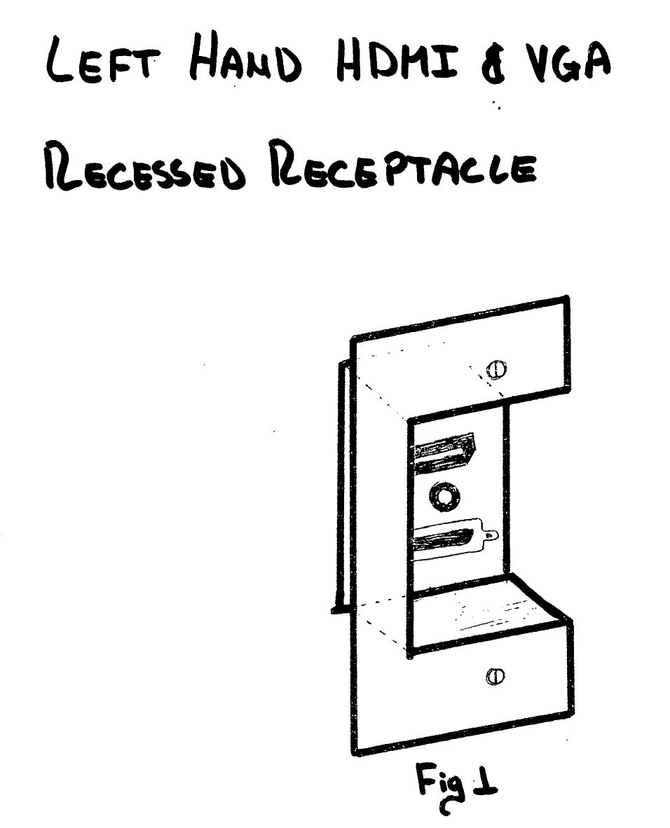

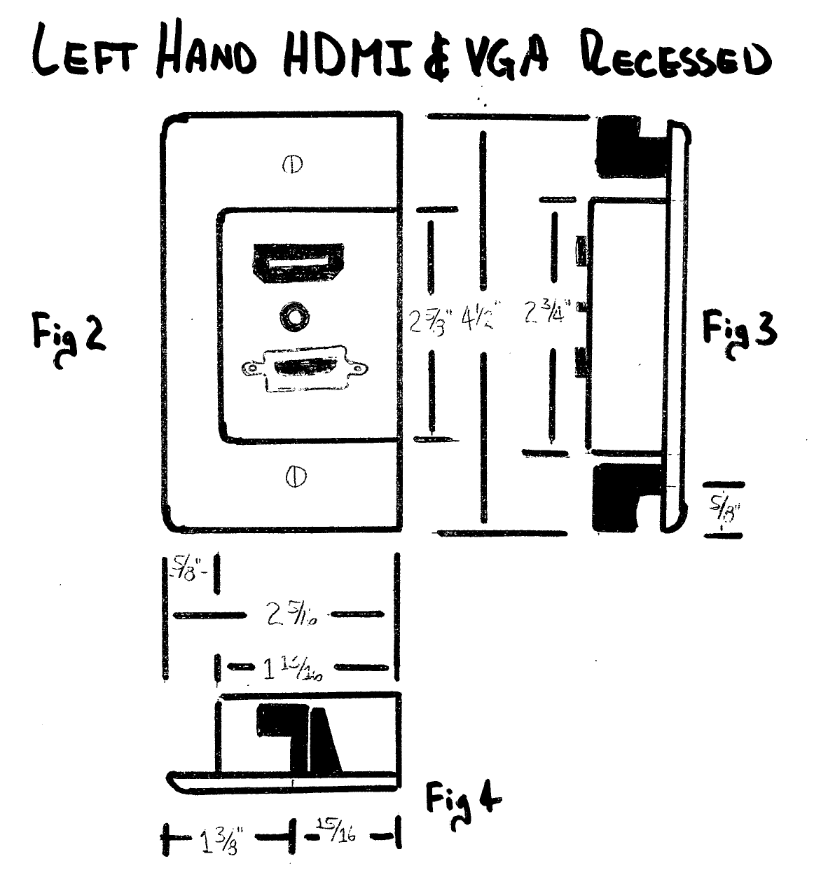

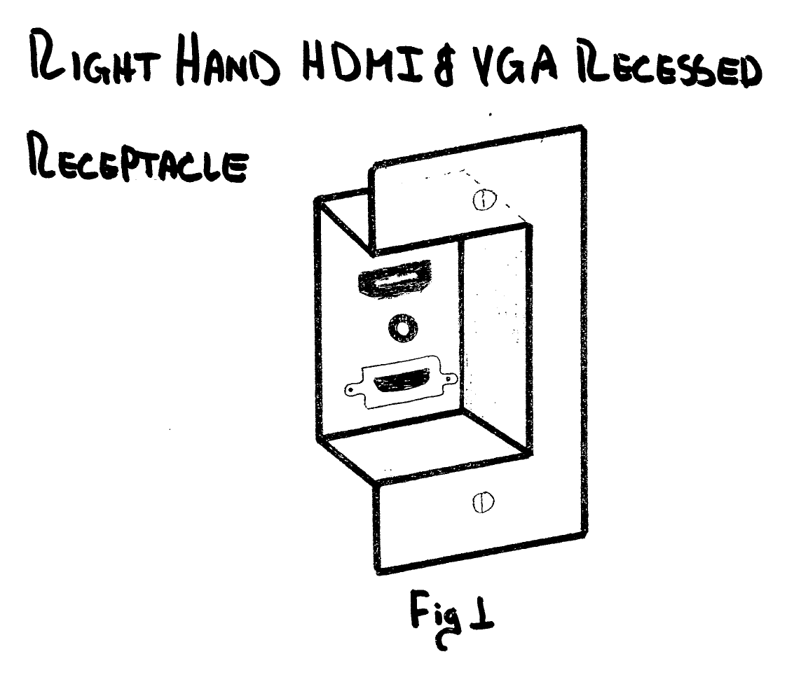

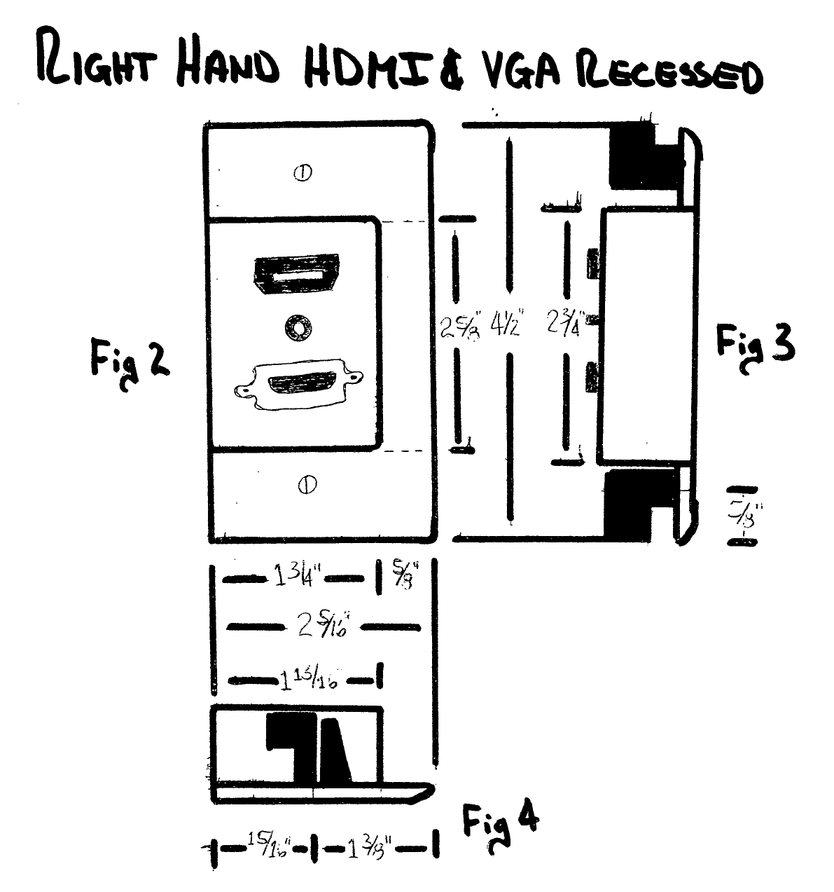

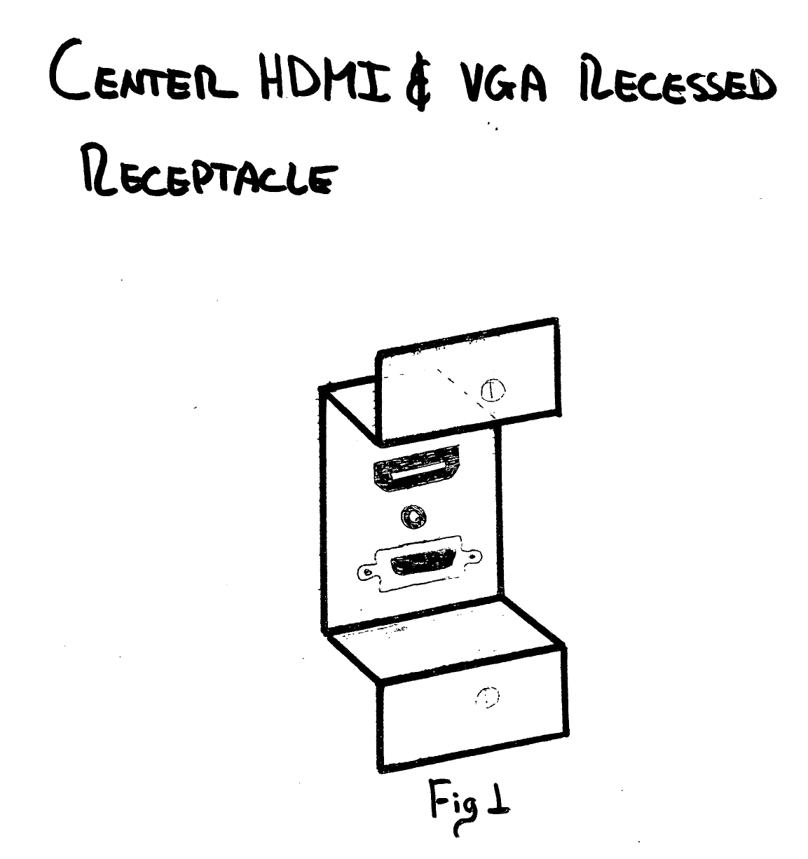

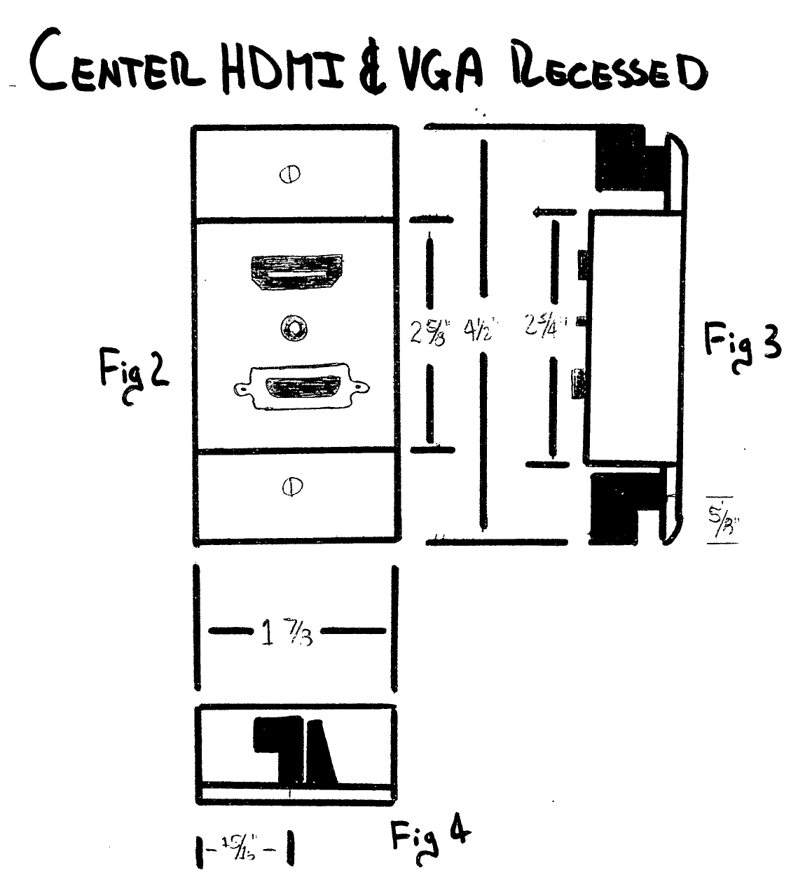

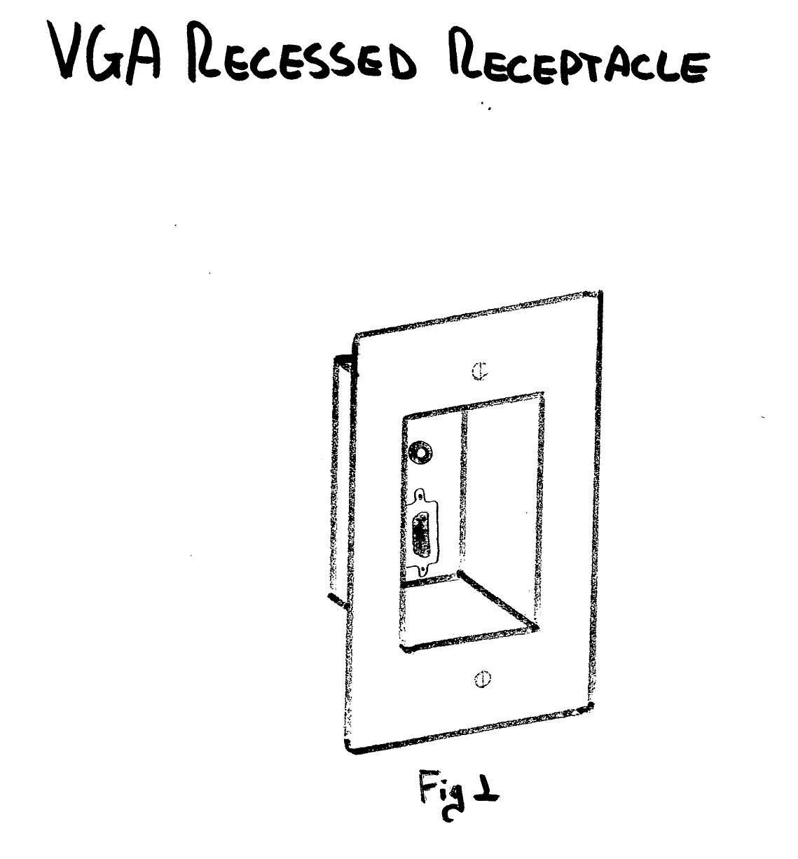

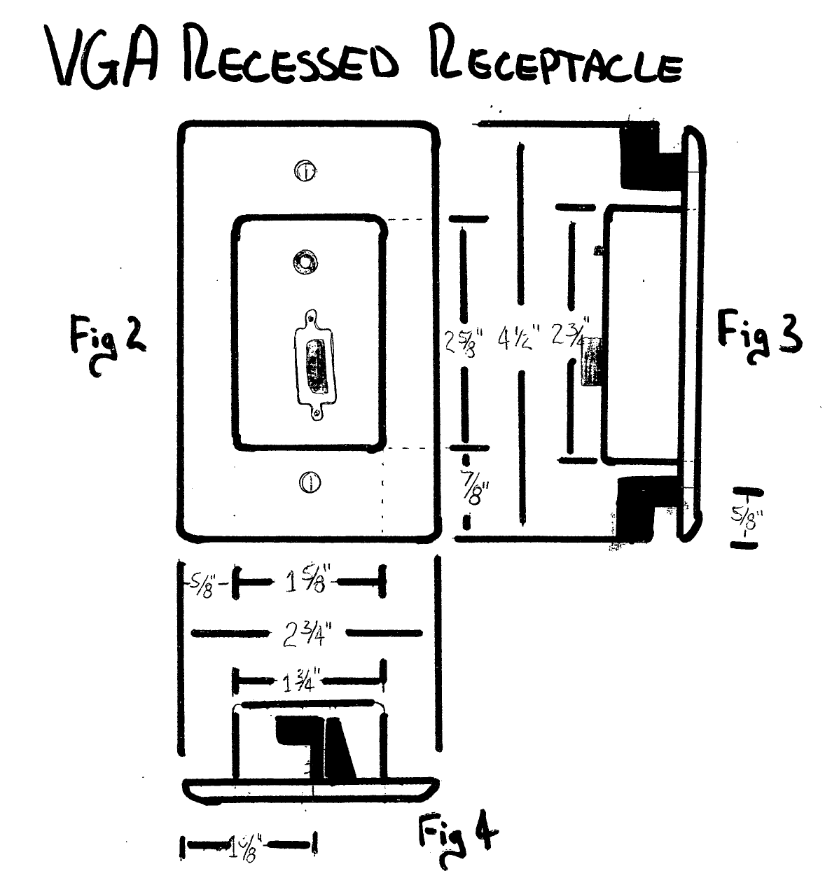

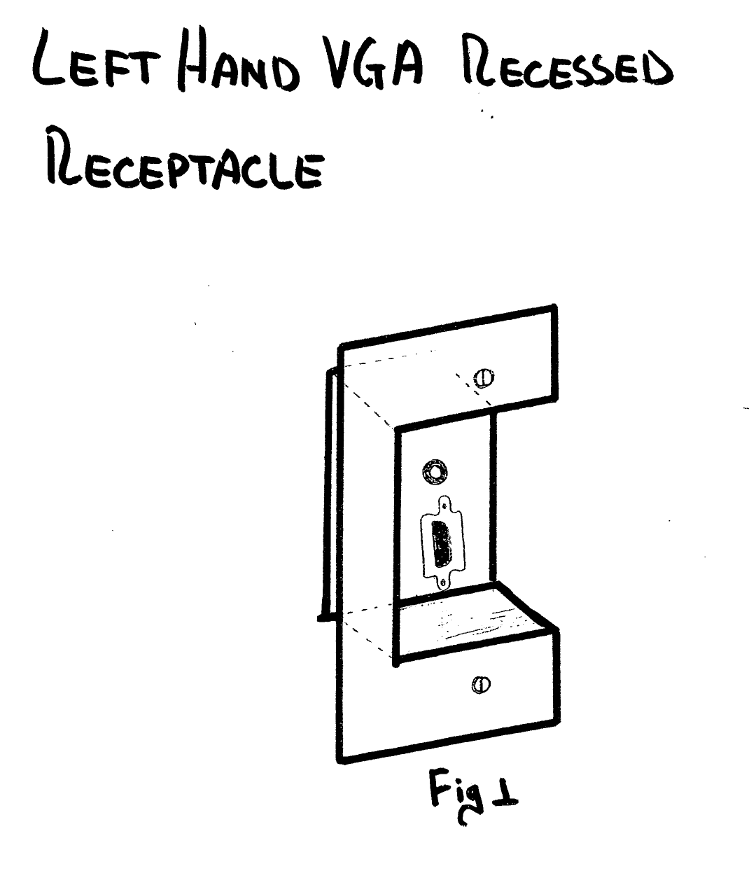

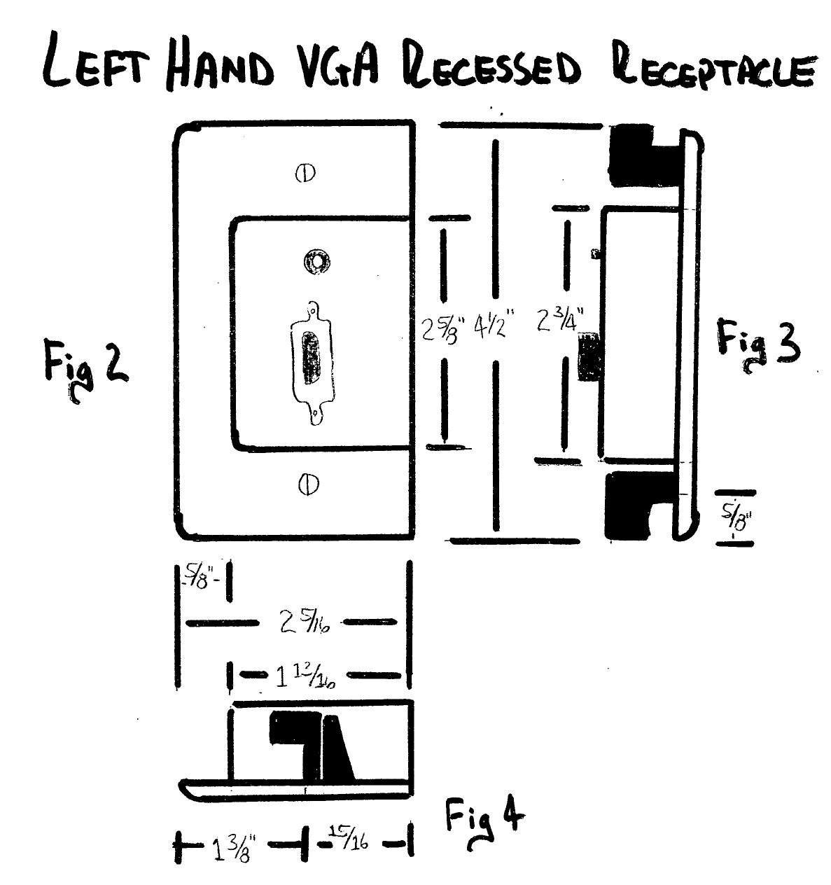

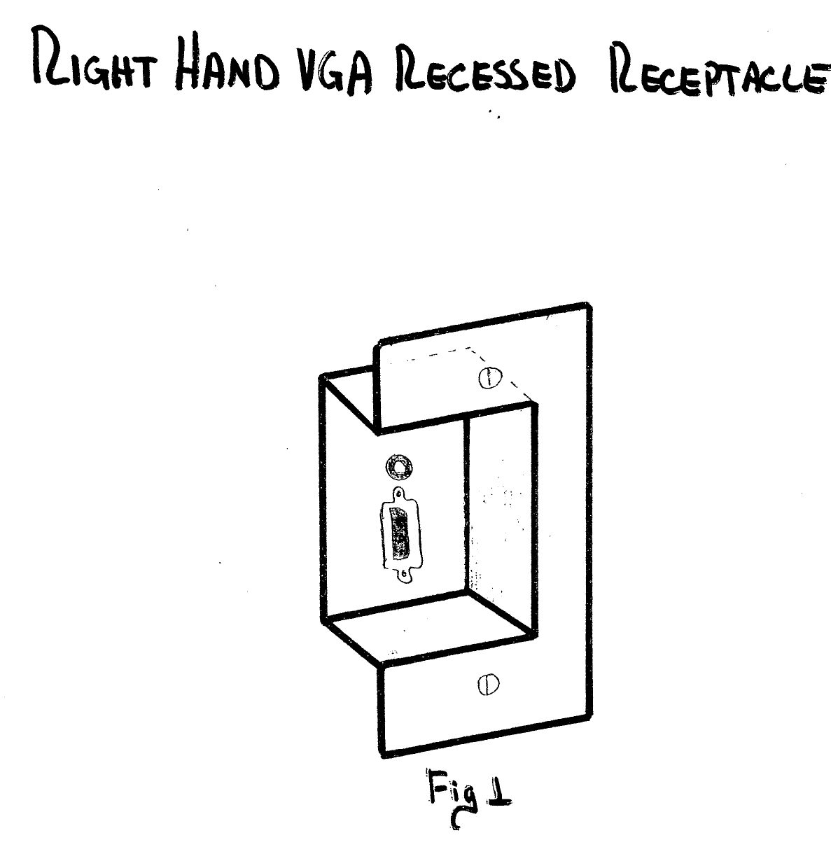

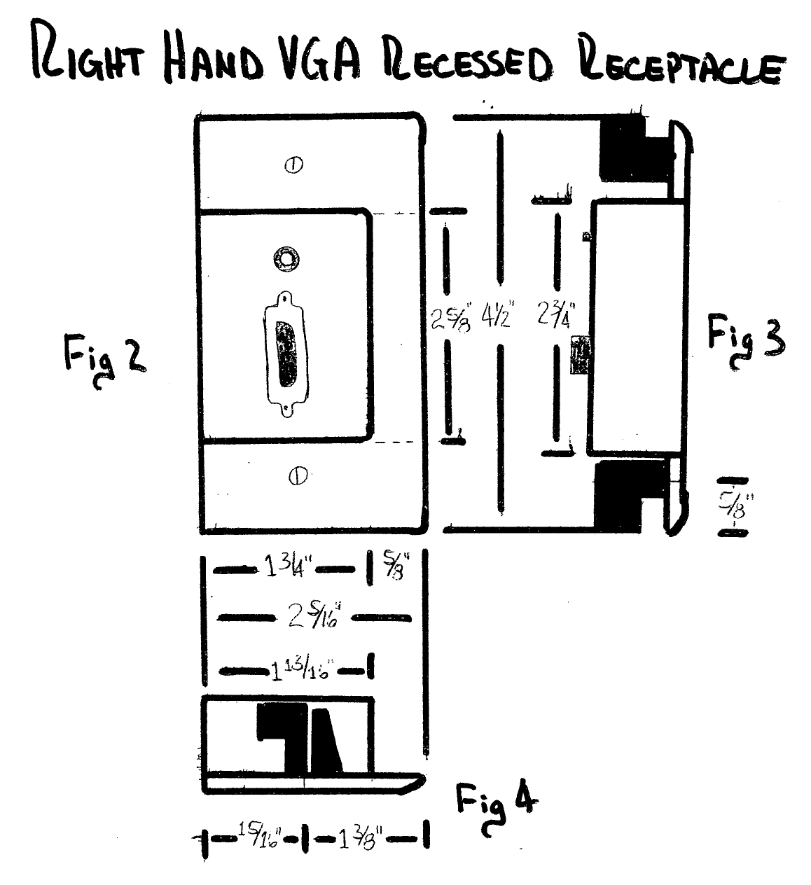

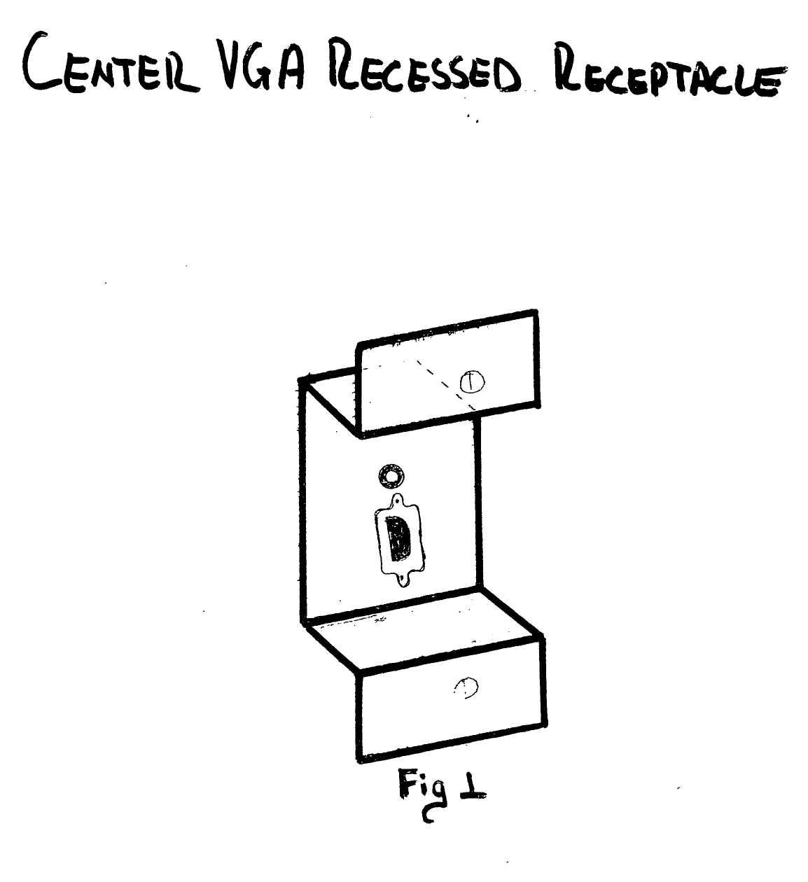

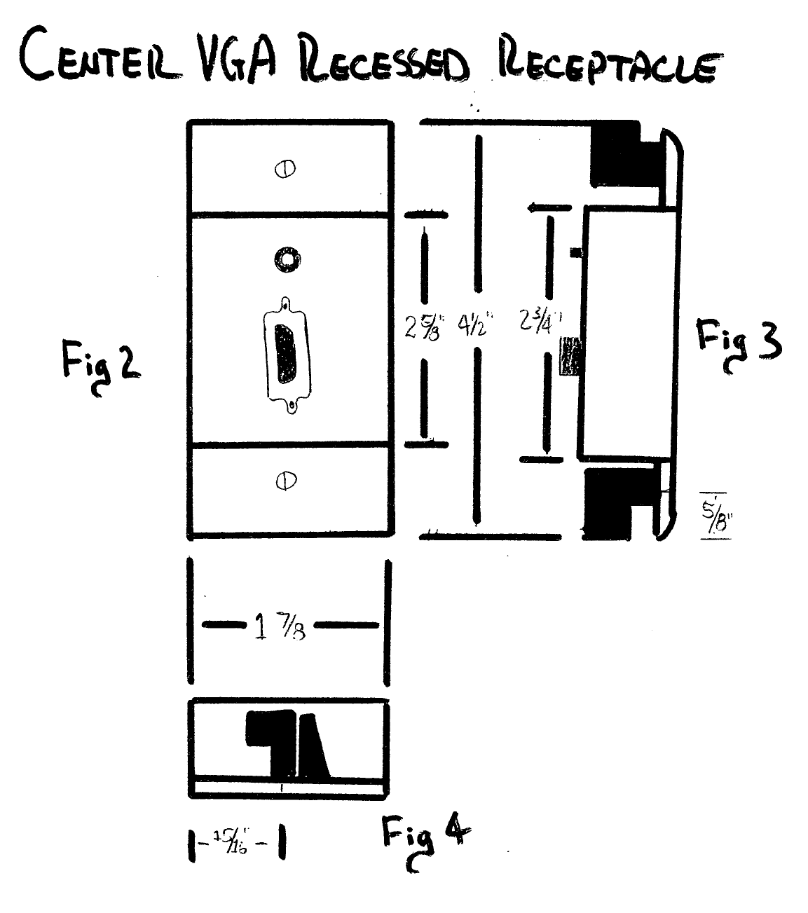

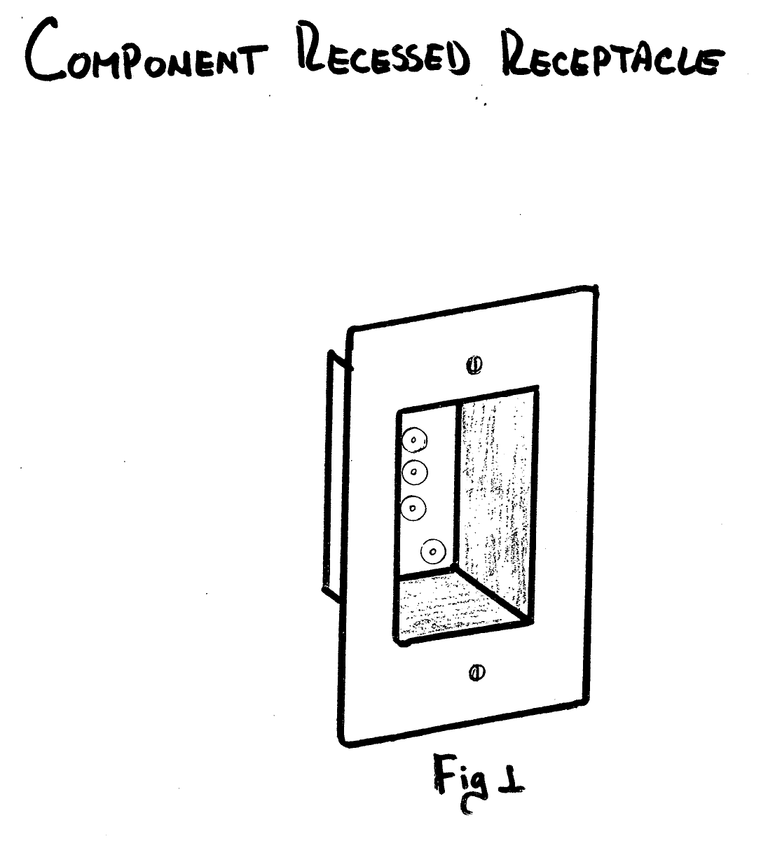

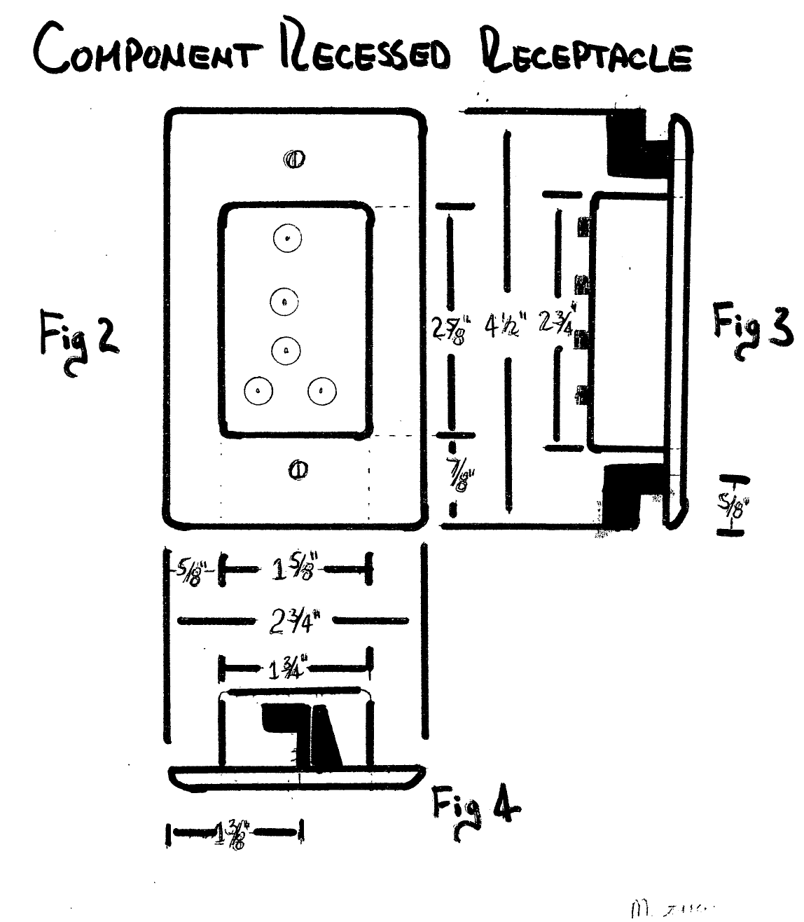

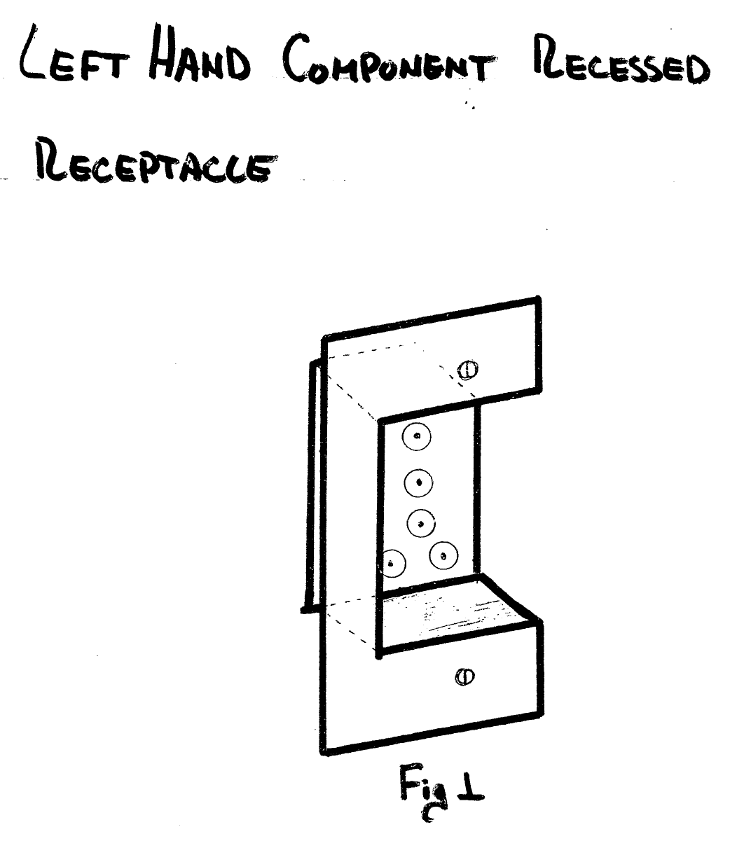

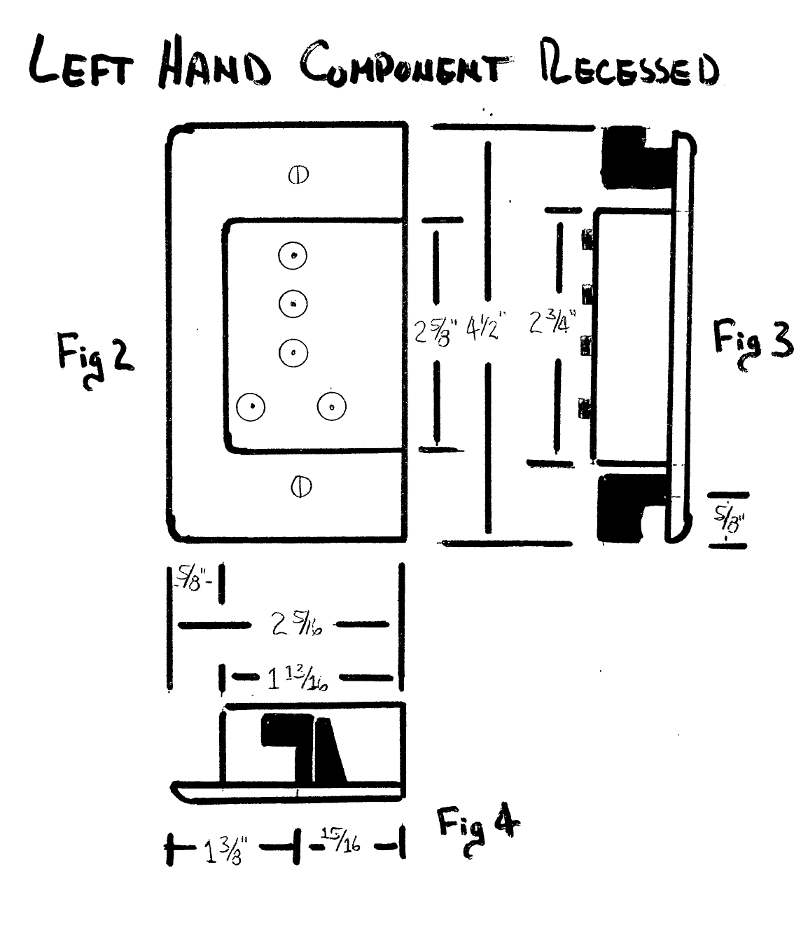

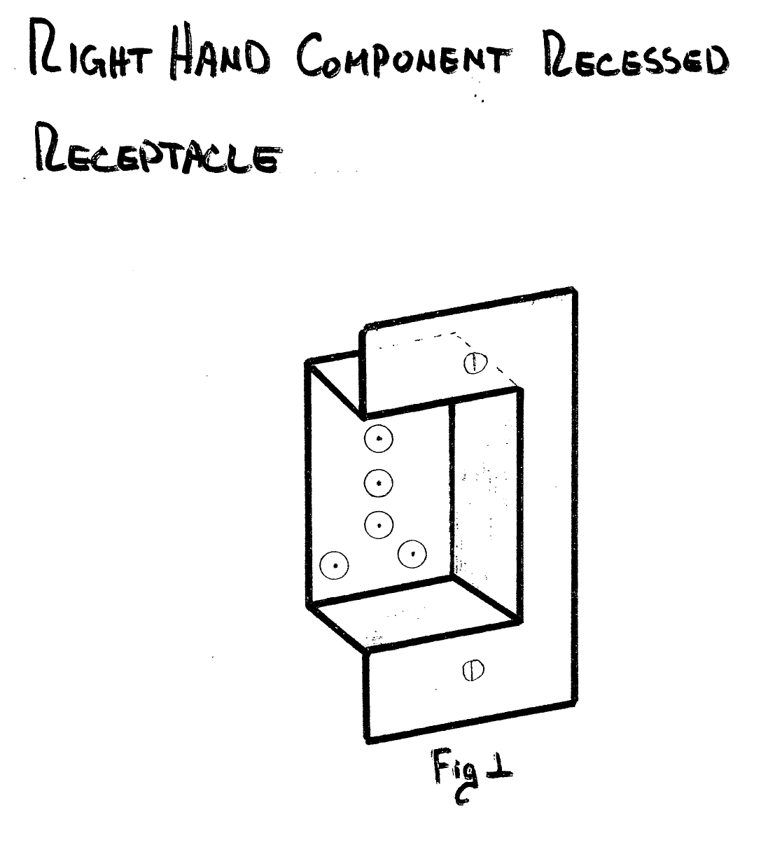

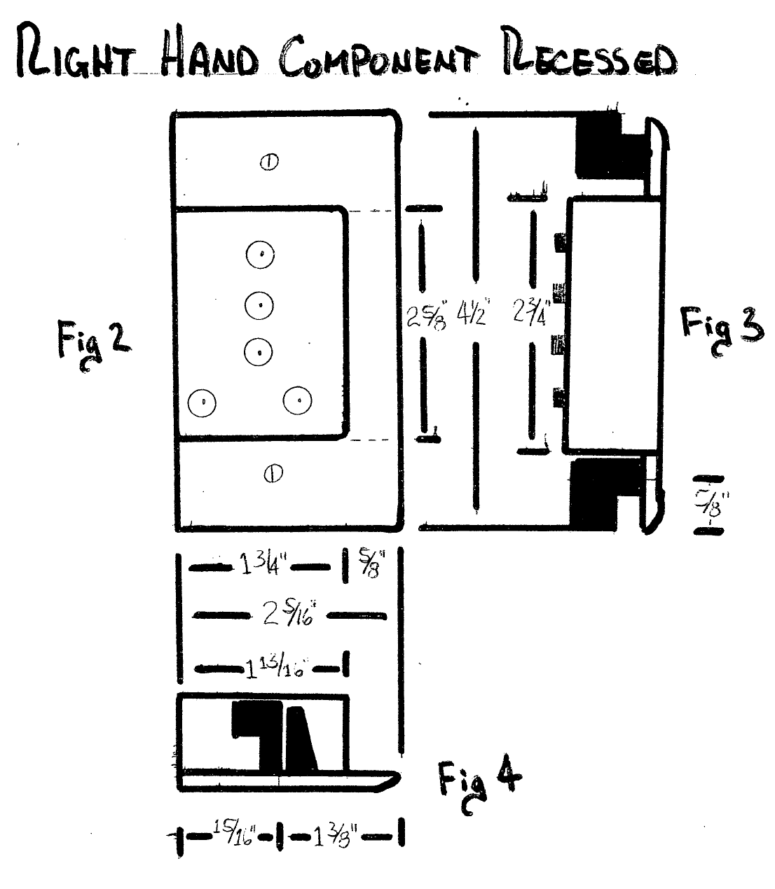

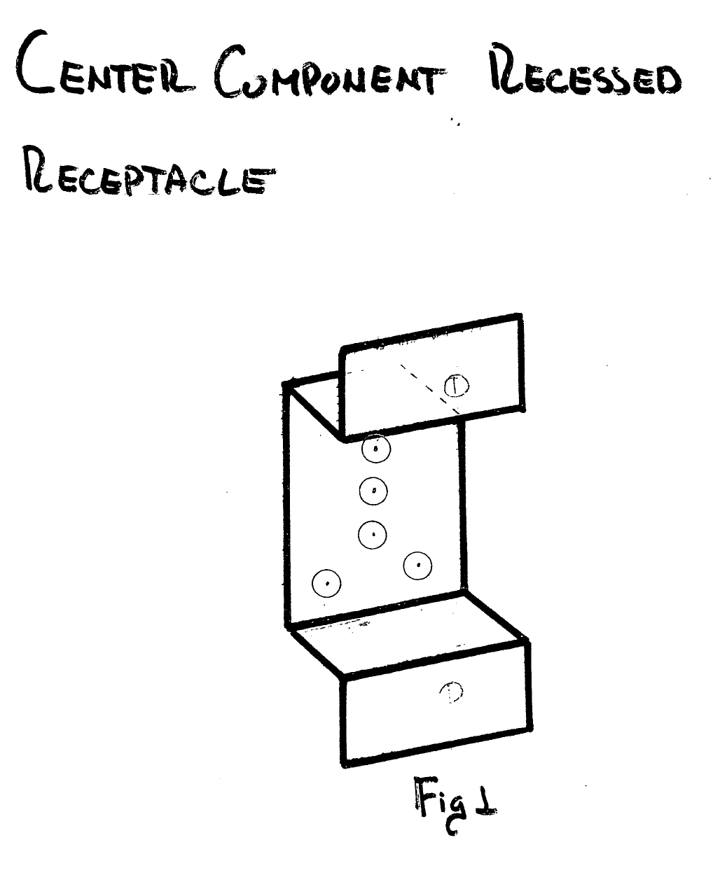

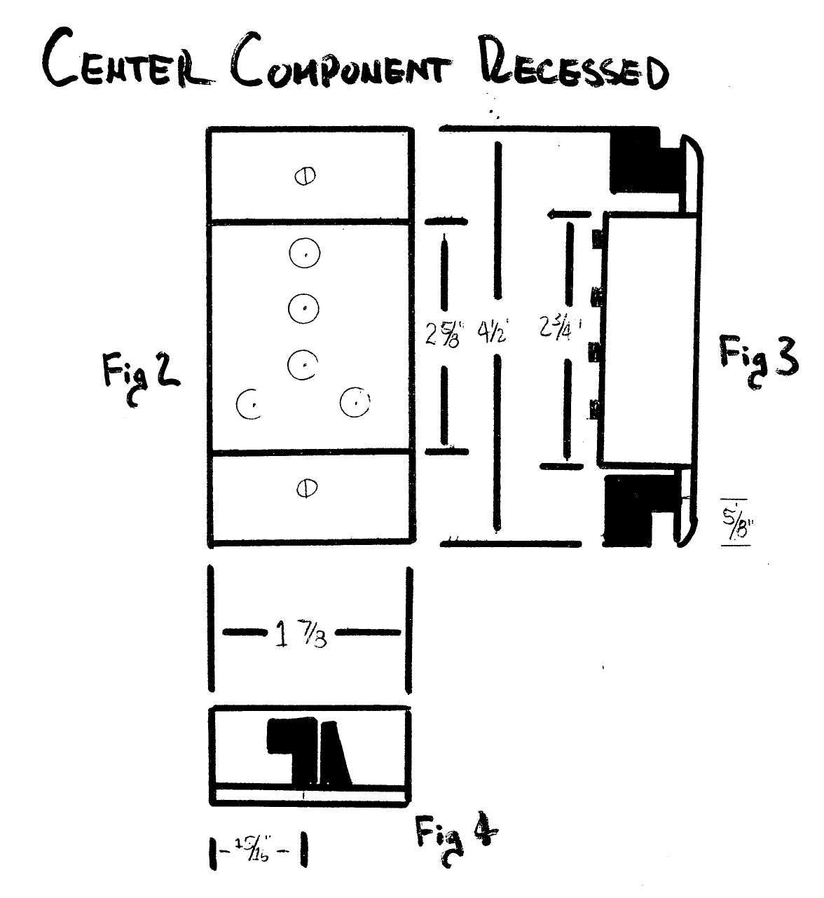

FIG. 1: A single gang, stand alone receptacle with HDMI & Coax outputs
FIG. 2: The front face of the device
FIG. 3: The side view, showing the HDMI & Coax couplings, and the removable wall clips.
FIG. 4: The top view, showing the removable wall clip.

### Left Hand HDMI & Coax Recessed Receptacle

FIG. 1: A left hand end piece to a multiple gang, receptacle with HDMI & Coax outputs
FIG. 2: The front face of the device
FIG. 3: The side view, showing the HDMI & Coax couplings, and the removable wall clips.
FIG. 4: The top view, showing the removable wall clip.

### Right Hand HDMI & Coax Recessed Receptacle

FIG. 1: A right hand end piece to a multiple gang, receptacle with HDMI & Coax outputs
FIG. 2: The front face of the device
FIG. 3: The side view, showing the HDMI & Coax couplings, and the removable wall clips.
FIG. 4: The top view, showing the removable wall clip.

### Center HDMI & Coax Recessed Receptacle

FIG. 1: The center piece to a multiple gang, receptacle with HDMI & Coax outputs
FIG. 2: The front face of the device
FIG. 3: The side view, showing the HDMI & Coax couplings, and the removable wall clips.
FIG. 4: The top view, showing the removable wall clip.

### HDMI Recessed Receptacle

FIG. 1: A single gang, stand alone receptacle with an HDMI output.
FIG. 2: The front face of the device
FIG. 3: The side view, showing the HDMI coupling, and the removable wall clips.
FIG. 4: The top view, showing the removable wall clip.

### Left Hand HDMI Recessed Receptacle

FIG. 1: A left hand end piece to a multiple gang, receptacle with an HDMI output.
FIG. 2: The front face of the device
FIG. 3: The side view, showing the HDMI coupling, and the removable wall clips.
FIG. 4: The top view, showing the removable wall clip.

### Right Hand HDMI Recessed Receptacle

FIG. 1: A right hand end piece to a multiple gang, receptacle with an HDMI output.
FIG. 2: The front face of the device
FIG. 3: The side view, showing the HDMI coupling, and the removable wall clips.
FIG. 4: The top view, showing the removable wall clip.

### Center HDMI Recessed Receptacle

FIG. 1: The center piece to a multiple gang, receptacle with an HDMI output.
FIG. 2: The front face of the device
FIG. 3: The side view, showing the HDMI coupling, and the removable wall clips.
FIG. 4: The top view, showing the removable wall clips

### Dual HDMI Recessed Receptacle

FIG. 1: A single gang, stand alone receptacle with Dual HDMI outputs.
FIG. 2: The front face of the device
FIG. 3: The side view, showing the 2 HDMI couplings, and the removable wall clips.
FIG. 4: The top view, showing the removable wall clip.

### Left Hand Dual HDMI Recessed Receptacle

FIG. 1: A left hand end piece to a multiple gang, receptacle with Dual HDMI outputs.
FIG. 2: The front face of the device
FIG. 3: The side view, showing the 2 HDMI couplings, and the removable wall clips.
FIG. 4: The top view, showing the removable wall clip.

### Right Hand Dual HDMI Recessed Receptacle

FIG. 1: A right hand end piece to a multiple gang, receptacle with Dual HDMI outputs.
FIG. 2: The front face of the device
FIG. 3: The side view, showing the 2 HDMI couplings, and the removable wall clips.
FIG. 4: The top view, showing the removable wall clip.

### Center Dual HDMI Recessed Receptacle

FIG. 1: The center piece to a multiple gang, receptacle with Dual HDMI outputs.
FIG. 2: The front face of the device
FIG. 3: The side view, showing the 2 HDMI couplings, and the removable wall clips.
FIG. 4: The top view, showing the removable wall clip.

### HDMI & VGA Recessed Receptacle

FIG. 1: A single gang, stand alone receptacle with HDMI & VGA outputs.
FIG. 2: The front face of the device
FIG. 3: The side view, showing the HDMI & VGA couplings, and the removable wall clips.
FIG. 4: The top view, showing the removable wall clip.

### Left Hand HDMI & VGA Recessed Receptacle

FIG. 1: A left hand end piece to a multiple gang, receptacle with HDMI & VGA outputs.
FIG. 2: The front face of the device.
FIG. 3: The side view, showing the HDMI & VGA couplings, and the removable wall clips.
FIG. 4: The top view, showing the removable wall clip.

### Right Hand HDMI & VGA Recessed Receptacle

FIG. 1: A right hand end piece to a multiple gang, receptacle with HDMI & VGA outputs.
FIG. 2: The front face of the device.
FIG. 3: The side view, showing the HDMI & VGA couplings, and the removable wall clips.
FIG. 4: The top view, showing the removable wall clip.

### Center HDMI & VGA Recessed Receptacle

FIG. 1: The center piece to a multiple gang, receptacle with HDMI & VGA outputs.
FIG. 2: The front face of the device.
FIG. 3: The side view, showing the HDMI & VGA couplings, and the removable wall clips.
FIG. 4: The top view, showing the removable wall clip.

### VGA Recessed Receptacle

FIG. 1: A single gang, stand alone receptacle with a VGA & 3.5 mm audio outputs.
FIG. 2: The front face of the device.
FIG. 3: The side view, showing the VGA & 3.5 mm audio couplings, and the removable wall clips.
FIG. 4: The top view, showing the removable wall clip.

### Left Hand VGA Recessed Receptacle

FIG. 1: A left hand end piece to a multiple gang, receptacle with VGA & 3.5 mm audio outputs.
FIG. 2: The front face of the device.
FIG. 3: The side view, showing the VGA & 3.5 mm audio couplings, and the removable wall clips.
FIG. 4: The top view, showing the removable wall clip.

### Right Hand VGA Recessed Receptacle

FIG. 1: A right hand end piece to a multiple gang, receptacle with VGA & 3.5 mm audio outputs.
FIG. 2: The front face of the device
FIG. 3: The side view, showing the VGA & 3.5 mm audio couplings, and the removable wall clips.
FIG. 4: The top view, showing the removable wall clip.

### Center VGA Recessed Receptacle

FIG. 1: The center piece to a multiple gang, receptacle with VGA & 3.5 mm audio outputs.
FIG. 2: The front face of the device.
FIG. 3: The side view, showing the VGA & 3.5 mm audio couplings, and the removable wall clips.
FIG. 4: The top view, showing the removable wall clip.

### Component Recessed Receptacle

FIG. 1: A single gang, stand alone receptacle with Component outputs.
FIG. 2: The front face of the device
FIG. 3: The side view, showing the RCA couplings, and the removable wall clips.
FIG. 4: The top view, showing the removable wall clip.

### Left Hand Component Recessed Receptacle

FIG. 1: A left hand end piece to a multiple gang, receptacle with Component outputs.
FIG. 2: The front face of the device.
FIG. 3: The side view, showing the RCA couplings, and the removable wall clips.
FIG. 4: The top view, showing the removable wall clip.

### Right Hand Component Recessed Receptacle

FIG. 1: A right hand end piece to a multiple gang, receptacle with Component outputs.
FIG. 2: The front face of the device.
FIG. 3: The side view, showing the RCA couplings, and the removable wall clips.
FIG. 4: The top view, showing the removable wall clip.

### Center Component Recessed Receptacle

FIG. 1: The center piece to a multiple gang, receptacle with Component outputs.
FIG. 2: The front face of the device.
FIG. 3: The side view, showing the RCA couplings, and the removable wall clips.
FIG. 4: The top view, showing the removable wall clip.

1. The uniqueness of this invention is that low voltage TV inputs can now be ganged together in numerous configuration, with a recessed device. It eliminates the need to locate a specific electrical box or plaster ring, because each piece is cut into, and clips onto the wallboard. This makes the system adaptable to future remodel expansion, as new sections can be added without having to change internal supports. The clips can be removed, for new construction, and the devices can be used with a electrical box or plaster ring.
